(19) United States
(12) Patent Application Publication
(10) Pub. No.: US 2026/0169425 A1
(43) Pub. Date: Jun. 18, 2026

(54) ONE-WAY CLUTCH DEVICE, DRIVER, AND IMAGE FORMING APPARATUS

(71) Applicant: Shogo SAKAMOTO, Kanagawa (JP)

(72) Inventor: Shogo SAKAMOTO, Kanagawa (JP)

(73) Assignee: ETRIA CO., LTD., Yokohama (JP)

(21) Appl. No.: 19/337,333

(22) Filed: Sep. 23, 2025

(30) Foreign Application Priority Data
Dec. 18, 2024 (JP) 2024-221890

(51) Int. Cl. G03G 21/16; F16D 41/18; G03G 15/00; G03G 15/20; G03G 15/23

(52) U.S. Cl. CPC G03G 21/1647; F16D 41/185; G03G 15/2017; G03G 15/234; G03G 15/6552

(57) ABSTRACT

A one-way clutch device includes an input member, a joint, and an output member that engages the joint. The input member rotates in a driving force transmitting rotation direction to transmit a driving force and a driving force interrupting rotation direction to interrupt transmission of the driving force. The joint includes a plurality of first projections. The output member includes a plurality of second projections. Each of the first projections and the second projections includes a first slope and a second slope. The first slope has a height that decreases gradually from a tip of each of the first projections and the second projections in the driving force transmitting rotation direction. The second slope has a height that decreases gradually from the tip of each of the first projections and the second projections in the driving force interrupting rotation direction.

### CROSS-REFERENCE TO RELATED APPLICATION

This patent application is based on and claims priority pursuant to 35 U.S.C. § 119(a) to Japanese Patent Application No. 2024-221890, filed on Dec. 18, 2024, in the Japan Patent Office, the entire disclosure of which is hereby incorporated by reference herein.

### BACKGROUND

### Technical Field

The present disclosure relates to a one-way clutch device, a driver, and an image forming apparatus.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data.

Such image forming apparatuses include a one-way clutch device that includes an input member, an output member, and a joint. The input member includes an input engaging portion that receives a driving force from a driving source. The output member is coaxial with the input member. The output member includes an output engaging portion and outputs the driving force. The joint is movably disposed between the input member and the output member in an axial direction of the input member and the output member. The joint includes a first engaging portion that engages the input engaging portion and a second engaging portion that engages or meshes with the output engaging portion.

As the input member rotates in a driving force transmitting rotation direction to transmit the driving force to the output member that outputs the driving force, the input engaging portion engages the first engaging portion and the second engaging portion engages the output engaging portion to transmit the driving force. Conversely, as the input member rotates in a driving force interrupting rotation direction, that is opposite to the driving force transmitting rotation direction, to interrupt transmission of the driving force, the second engaging portion disengages the output engaging portion to interrupt transmission of the driving force.

### SUMMARY

The present disclosure described herein provides a one-way clutch device for transmitting a driving force generated by a driving source. The one-way clutch device includes an input member that receives the driving force from the driving source. The input member rotates in a driving force transmitting rotation direction to transmit the driving force and a driving force interrupting rotation direction opposite to the driving force transmitting rotation direction to interrupt transmission of the driving force. An output member outputs the driving force. A joint engages the output member and includes a plurality of first projections that is disposed opposite the output member. The first projections project in an axial direction of the joint and are arranged in a circumferential direction of the joint. The output member includes a plurality of second projections that is disposed opposite the joint. The second projections project in an axial direction of the output member and are arranged in a circumferential direction of the output member. Each of the first projections and the second projections includes a first slope and a second slope. The first slope has a height that decreases gradually from a tip of each of the first projections and the second projections in the driving force transmitting rotation direction. The second slope has a height that decreases gradually from the tip of each of the first projections and the second projections in the driving force interrupting rotation direction.

The present disclosure described herein further provides a driver including a driving source that rotates forward and backward and generates a driving force and a driving force transmitter that transmits the driving force. The driving force transmitter includes a first one-way clutch device and a second one-way clutch device that is disposed opposite the first one-way clutch device. Each of the first one-way clutch device and the second one-way clutch device is equivalent to the one-way clutch device described above.

The present disclosure described herein further provides an image forming apparatus including a driver, a first rotator that is coupled with the driver, and a second rotator that is coupled with the driver. The driver includes a driving source that rotates forward and backward and generates a driving force and a driving force transmitter that transmits the driving force. The driving force transmitter includes a first one-way clutch device and a second one-way clutch device that is disposed opposite the first one-way clutch device. Each of the first one-way clutch device and the second one-way clutch device is equivalent to the one-way clutch device described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of a printer according to an embodiment of the present disclosure;

FIG. 2 is an enlarged diagram of the printer depicted in FIG. 1, illustrating a photoconductor and peripheral components thereof;

FIG. 3 is a schematic cross-sectional view of the printer depicted in FIG. 1 in a state in which an open-close cover is opened;

FIG. 4 is a perspective view of a driver installable in the printer depicted in FIG. 1, illustrating a basic construction of the driver;

FIG. 5 is a perspective view of a forward rotation one-way clutch device and a backward rotation one-way clutch device of the driver depicted in FIG. 4;

FIG. 6 is a perspective view of the driver depicted in FIG. 4, illustrating the basic construction thereof that transmits a driving force when a driving motor rotates forward;

FIG. 7 is a perspective view of the driver depicted in FIG. 4, illustrating the basic construction thereof that transmits a driving force when the driving motor rotates backward;

FIG. 8A is a perspective view of the forward rotation one-way clutch device depicted in FIG. 5, illustrating an operation thereof when the driving motor rotates forward;

FIG. 8B is a perspective view of the forward rotation one-way clutch device depicted in FIG. 5, illustrating another operation thereof when the driving motor rotates forward;

FIG. 9A is a perspective view of the backward rotation one-way clutch device depicted in FIG. 5, illustrating an operation thereof when the driving motor rotates backward;

FIG. 9B is a perspective view of the backward rotation one-way clutch device depicted in FIG. 5, illustrating another operation thereof when the driving motor rotates backward;

FIG. 10 is a perspective view of the backward rotation one-way clutch device depicted in FIG. 5, that is attached with a forward rotation joint and a forward rotation output gear of the forward rotation one-way clutch device depicted in FIG. 8A;

FIG. 11 is a perspective view of a forward rotation one-way clutch device and a backward rotation one-way clutch device according to an embodiment of the present disclosure, that are installed in the printer depicted in FIG. 1;

FIG. 12 is a perspective view of a compatible joint incorporated in the forward rotation one-way clutch device and the backward rotation one-way clutch device depicted in FIG. 11;

FIG. 13A is a diagram of the forward rotation one-way clutch device depicted in FIG. 11, illustrating an operation thereof when the driving motor rotates backward;

FIG. 13B is a diagram of the backward rotation one-way clutch device depicted in FIG. 11, illustrating an operation thereof when the driving motor rotates forward;

FIG. 14A is a diagram of the forward rotation one-way clutch device depicted in FIG. 11, illustrating an operation thereof when the driving motor rotates forward;

FIG. 14B is a diagram of the backward rotation one-way clutch device depicted in FIG. 11, illustrating an operation thereof when the driving motor rotates backward;

FIG. 15 is a perspective view of a forward rotation one-way clutch device and a backward rotation one-way clutch device that incorporate compatible output gears, respectively, and are installable in the printer depicted in FIG. 1, as one example;

FIG. 16A is a diagram of a forward rotation one-way clutch device as a modification example of the forward rotation one-way clutch device depicted in FIG. 11;

FIG. 16B is a diagram of a backward rotation one-way clutch device as a modification example of the backward rotation one-way clutch device depicted in FIG. 11;

FIG. 17A is a diagram of a projection of a second engaging portion of the compatible joint and a projection of an output engaging portion of an output gear as a modification example of a projection of the forward rotation one-way clutch device and the backward rotation one-way clutch device depicted in FIG. 11; and

FIG. 17B is a diagram of a projection of the second engaging portion of the compatible joint and a projection of the output engaging portion of the output gear as another modification example of the projection of the forward rotation one-way clutch device and the backward rotation one-way clutch device depicted in FIG. 11.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is provided of a construction of a printer 1000 serving as an image forming apparatus applied with the technology of the present disclosure.

The printer 1000 is an electrophotographic printer that forms an image on a recording medium by an electrophotographic method. The technology of the present disclosure is described with the image forming apparatus employing the electrophotographic method. However, application of the technology of the present disclosure is not limited to the image forming apparatus employing the electrophotographic method. The technology of the present disclosure is also applied to image forming apparatuses employing an inkjet printing method, a screen printing method, and the like.

A description is provided of a basic construction of the printer 1000 according to an embodiment of the present disclosure.

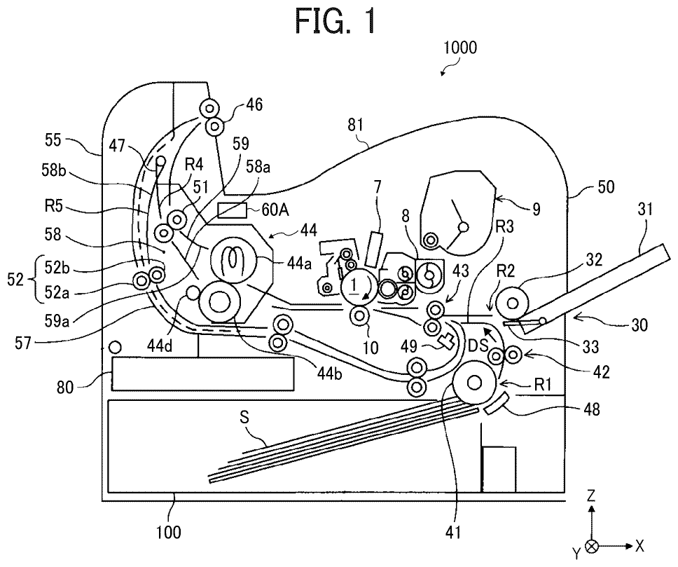

FIG. 1 is a schematic cross-sectional view of the printer 1000 according to the embodiment. FIG. 1 illustrates x-direction, y-direction, and z-direction that are defined as below and also applied to other figures. FIG. 1 illustrates a front of the printer 1000. The x-direction is parallel to a left-right direction of the printer 1000 and defines a rightward direction. The y-direction is parallel to a front-rear direction of the printer 1000 and defines a rearward direction. The z-direction is vertical and defines an upward direction.

As illustrated in FIG. 1, the printer 1000 includes a photoconductor 1, an apparatus body 50, and a sheet tray 100. The photoconductor 1 serves as a latent image bearer. The sheet tray 100 serves as a sheet storage that is removably installed in the apparatus body 50. The sheet tray 100 loads a plurality of recording sheets S as a sheaf of sheets.

The printer 1000 further includes a body feed roller 41, a separation pad 48, a body sheet feeding path R1, and a relay roller pair 42. As the body feed roller 41 is driven and rotated, the body feed roller 41 feeds a recording sheet S from the sheet tray 100. The body feed roller 41 and the separation pad 48 form a separation nip therebetween. At the separation nip, the body feed roller 41 and the separation pad 48 separate an uppermost recording sheet S from other recording sheets S and feed the uppermost recording sheet S to the body sheet feeding path R1 serving as a first conveyance path. The relay roller pair 42 serving as a conveyance roller pair is disposed above the body feed roller 41 and includes rollers that form a conveyance nip therebetween. The rollers of the relay roller pair 42 sandwich the recording sheet S at the conveyance nip. The relay roller pair 42 conveys the recording sheet S through the body sheet feeding path R1 downstream in a sheet conveyance direction DS. Alternatively, at least one of the rollers of the relay roller pair 42 serving as the conveyance roller pair may be replaced with a belt.

The printer 1000 further includes a shared conveyance path R3, a registration roller pair 43, and a registration sensor 49. The body sheet feeding path R1 includes a downstream end that communicates with the shared conveyance path R3. The registration roller pair 43 is disposed in the shared conveyance path R3. The registration sensor 49 is disposed in the shared conveyance path R3 and disposed upstream from the registration roller pair 43 in the sheet conveyance direction DS. The registration sensor 49 detects the recording sheet S. The registration roller pair 43 that interrupts rotation temporarily stops the recording sheet S in a state in which a leading end of the recording sheet S strikes a nip formed between two rollers of the registration roller pair 43. As the recording sheet S strikes the nip of the registration roller pair 43, the registration roller pair 43 corrects skew of the recording sheet S. The registration sensor 49 is also used for an initial operation of the printer 1000, checking of a residual recording sheet S when the printer 1000 resumes an operation after the printer 1000 interrupts the operation due to a failure, and the like.

The printer 1000 further includes a transfer roller 10. The photoconductor 1 and the transfer roller 10 form a transfer nip therebetween, through which the recording sheet S is conveyed. The registration roller pair 43 resumes rotation to convey the recording sheet S to the transfer nip so that the recording sheet S meets a toner image formed on a surface of the photoconductor 1 at the transfer nip. The relay roller pair 42 starts rotation simultaneously, resuming conveyance of the recording sheet S that stops temporarily.

The apparatus body 50 of the printer 1000 is provided with a bypass sheet feeding path R2 and a bypass sheet feeder 30 serving as a bypass feeder that includes a bypass tray 31, a bypass sheet feed roller 32, a separation pad 33, a bypass base plate, and a bypass base plate cam. As a user places a recording sheet S on the bypass tray 31 of the bypass sheet feeder 30, the bypass sheet feed roller 32 that is driven and rotated feeds the recording sheet S from the bypass tray 31 to the bypass sheet feeding path R2 serving as a second conveyance path. The bypass sheet feeding path R2 includes a downstream end that adjoins the shared conveyance path R3 with the downstream end of the body sheet feeding path R1. The bypass sheet feed roller 32 contacts the separation pad 33 to form a separation nip therebetween. The recording sheet S fed by the bypass sheet feed roller 32 passes through the separation nip in the bypass sheet feeding path R2. Thereafter, the recording sheet S is sent to the shared conveyance path R3 and conveyed to the registration roller pair 43. Thereafter, like the recording sheet S sent from the sheet tray 100, the recording sheet S passes through the registration roller pair 43 and is conveyed to the transfer nip.

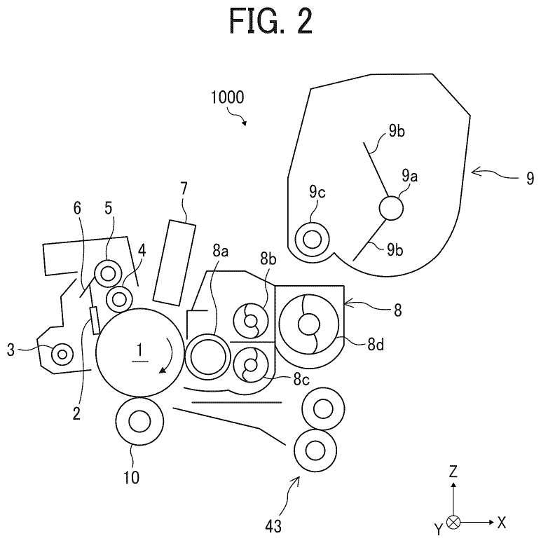

FIG. 2 is an enlarged diagram of the printer 1000, illustrating the photoconductor 1 and peripheral components thereof.

The photoconductor 1 is drum-shaped and is driven and rotated clockwise in FIG. 2. The photoconductor 1 is surrounded by a cleaning blade 2, a collecting screw 3, a charging roller 4, a charge cleaning roller 5, a scraper 6, a latent image writer 7, a developing device 8, the transfer roller 10, and the like. The charging roller 4 includes a conductive rubber roller portion. The charging roller 4 rotates in a state in which the charging roller 4 contacts the photoconductor 1 to form a charging nip therebetween. The charging roller 4 is applied with a voltage from a charging power supply. Accordingly, a charging bias generates between the surface of the photoconductor 1 and a surface of the charging roller 4 at the charging nip, thus uniformly charging the surface of the photoconductor 1.

The latent image writer 7 includes a light-emitting diode (LED) array. The latent image writer 7 performs optical writing on the uniformly charged surface of the photoconductor 1 with writing light (e.g., LED light). The uniformly charged surface of the photoconductor 1 has an irradiation region irradiated with the writing light. The irradiation region has an attenuated electric potential, thus forming an electrostatic latent image on the surface of the photoconductor 1.

As the photoconductor 1 rotates, the electrostatic latent image formed on the photoconductor 1 passes through a developing region disposed opposite the developing device 8. The developing device 8 includes a circulation-conveyance portion and a developing portion. The circulation-conveyance portion stores a developer containing toner and magnetic carriers. The developing device 8 further includes a developing roller 8a, a first screw 8b, a second screw 8c, and an inclined screw 8d. The circulation-conveyance portion includes the first screw 8b, the second screw 8c, and the inclined screw 8d. The first screw 8b conveys and supplies the developer to the developing roller 8a. The second screw 8c is disposed in a compartment that is disposed immediately below and separated from the first screw 8b. The second screw 8c conveys the developer. The inclined screw 8d conveys the developer from the second screw 8c to the first screw 8b. The developing roller 8a, the first screw 8b, and the second screw 8c are parallel to each other. Conversely, the inclined screw 8d is inclined with respect to the developing roller 8a, the first screw 8b, and the second screw 8c.

As the first screw 8b is driven and rotated, the first screw 8b conveys the developer from a rear to a front of the developing device 8 in a direction perpendicular to a paper surface of FIG. 2. The first screw 8b supplies a part of the developer onto the developing roller 8a disposed opposite the first screw 8b. As the first screw 8b conveys the developer to a position in proximity to a front end of the first screw 8b in the direction perpendicular to the paper surface of FIG. 2, the developer falls onto the second screw 8c.

While the second screw 8c receives the used developer from the developing roller 8a, as the second screw 8c is driven and rotated, the second screw 8c conveys the received developer from the rear to the front of the developing device 8 in the direction perpendicular to the paper surface of FIG. 2. As the second screw 8c conveys the developer to a position in proximity to a front end of the second screw 8c in the direction perpendicular to the paper surface of FIG. 2, the developer moves onto the inclined screw 8d. As the inclined screw 8d is driven and rotated, the inclined screw 8d conveys the developer from the front to the rear of the developing device 8 in the direction perpendicular to the paper surface of FIG. 2. Thereafter, the inclined screw 8d conveys the developer onto the first screw 8b at a position in proximity to a rear end of the inclined screw 8d in the direction perpendicular to the paper surface of FIG. 2.

The developing roller 8a includes a developing sleeve and a magnet roller. The developing sleeve is tubular and rotatable and is made of a non-magnetic member. The magnet roller is stationarily disposed inside the developing sleeve such that the magnet roller does not rotate in accordance with rotation of the developing sleeve. The magnet roller generates a magnetic force that draws a part of the developer conveyed by the first screw 8b onto a surface of the developing sleeve. As the developing sleeve rotates, the developing sleeve conveys the developer borne on the surface of the developing sleeve. The developing device 8 further includes a doctor blade. While the developer borne on the developing sleeve moves under the doctor blade disposed opposite the developing sleeve, the doctor blade regulates a thickness of a layer of the developer. Thereafter, the developing sleeve conveys the developer in the developing region where the developing sleeve is disposed opposite the photoconductor 1 while the developer slides over the surface of the photoconductor 1.

The developing sleeve is applied with a developing bias having a polarity that is identical to a polarity of an electric potential of toner and the photoconductor 1 uniformly charged (e.g., an electric potential of a background surface of the photoconductor 1). An absolute value of the developing bias is greater than an absolute value of an electric potential of a latent image and is smaller than an absolute value of an electric potential of the background surface of the photoconductor 1. Hence, the developing region is applied with a developing potential between an electrostatic latent image on the photoconductor 1 and the developing sleeve. The developing potential electrostatically moves toner from the developing sleeve onto the photoconductor 1. Conversely, a background potential is applied between the background surface of the photoconductor 1 and the developing sleeve. The background potential electrostatically moves toner from the photoconductor 1 onto the developing sleeve. Accordingly, in the developing region, toner is selectively adhered to the electrostatic latent image on the photoconductor 1, developing the electrostatic latent image into a toner image.

As the developing sleeve rotates, the developer that passes through the developing region enters an opposed region where the developing sleeve is disposed opposite the second screw 8c. The magnet roller includes a plurality of magnetic poles including two magnetic poles that have an identical polarity. In the opposed region, the two magnetic poles generate a repulsive magnetic field. The repulsive magnetic field separates the developer that enters the opposed region from the surface of the developing sleeve. The second screw 8c collects the developer.

The developer conveyed by the inclined screw 8d contains the developer collected from the developing roller 8a. Since the developer is used for developing the electrostatic latent image into the toner image in the developing region, the developer has a decreased toner density. The developing device 8 further includes a toner density sensor that detects a toner density of the developer conveyed by the inclined screw 8d. As illustrated in FIG. 1, the printer 1000 further includes a controller 80 including a semiconductor circuit such as a central processing unit (CPU). Based on a detection result provided by the toner density sensor, the controller 80 outputs a replenishing signal for supplying toner to the developer conveyed by the inclined screw 8d as needed.

As illustrated in FIG. 2, the printer 1000 further includes a toner cartridge 9 that is disposed above the developing device 8. The toner cartridge 9 includes a rotation shaft 9a, an agitator 9b, and a toner supply 9c. The agitator 9b secured to the rotation shaft 9a agitates toner inside the toner cartridge 9. As the toner supply 9c is driven and rotated based on the replenishing signal output from the controller 80, the toner supply 9c supplies toner in an amount corresponding to an amount of driving and rotation of the toner supply 9c onto the inclined screw 8d of the developing device 8.

As the photoconductor 1 rotates, the toner image formed on the photoconductor 1 by the developing device 8 enters the transfer nip formed between the photoconductor 1 and the transfer roller 10 that contacts the photoconductor 1. The transfer roller 10 is applied with a voltage having a polarity opposite to a polarity of a latent image potential of the electrostatic latent image on the photoconductor 1. Thus, a transfer bias is created at the transfer nip.

As described above, the registration roller pair 43 conveys the recording sheet S to the transfer nip so that the recording sheet S meets the toner image formed on the photoconductor 1 at the transfer nip. The transfer roller 10 transfers the toner image formed on the photoconductor 1 onto the recording sheet S that comes into close contact with the toner image at the transfer nip under the transfer bias and nip pressure.

After the toner image on the photoconductor 1 passes through the transfer nip, the surface of the photoconductor 1 is adhered with residual toner failed to be transferred onto the recording sheet S. The printer 1000 further includes a waste toner bottle. The cleaning blade 2 contacting the photoconductor 1 scrapes the residual toner off the surface of the photoconductor 1. Thereafter, the collecting screw 3 conveys the residual toner into the waste toner bottle.

The printer 1000 further includes a discharger. The discharger discharges the surface of the photoconductor 1 cleaned by the cleaning blade 2. Thereafter, the charging roller 4 uniformly charges the surface of the photoconductor 1 again. The charging roller 4 contacting the surface of the photoconductor 1 is adhered with a foreign substance such as a toner additive and toner failed to be removed by the cleaning blade 2. After the foreign substance is transferred onto the charge cleaning roller 5 contacting the charging roller 4, the scraper 6 contacting the charge cleaning roller 5 scrapes the foreign substance off a surface of the charge cleaning roller 5. The scraped foreign substance falls onto the collecting screw 3 described above.

As illustrated in FIG. 1, the printer 1000 further includes a fixing device 44, a sheet ejection path R4, and a sheet ejection-reverse roller pair 46. After the recording sheet S passes through the transfer nip formed between the photoconductor 1 and the transfer roller 10 contacting the photoconductor 1, the recording sheet S is conveyed to the fixing device 44. The fixing device 44 includes a fixing roller 44a and a pressure roller 44b. The fixing roller 44a accommodates a heat generator such as a halogen lamp. The pressure roller 44b presses against and contacts the fixing roller 44a to form a fixing nip therebetween. The fixing roller 44a and the pressure roller 44b fix the toner image on a surface of the recording sheet S sandwiched between the fixing roller 44a and the pressure roller 44b at the fixing nip under heat and pressure. After the recording sheet S passes through the fixing device 44, the recording sheet S passes through the sheet ejection path R4. The sheet ejection-reverse roller pair 46 is constructed of rollers that form a sheet ejection nip therebetween. The recording sheet S is sandwiched between the rollers at the sheet ejection nip.

The printer 1000 switches between a one-sided printing mode and a duplex printing mode. In the one-sided printing mode, the printer 1000 forms a toner image on one side of a recording sheet S. In the duplex printing mode, the printer 1000 forms toner images on both sides of a recording sheet S, respectively. In the one-sided printing mode and the duplex printing mode in which the recording sheet S already bears the toner images on both sides of the recording sheet S, respectively, the sheet ejection-reverse roller pair 46 continues rotating forward to eject the recording sheet S from the sheet ejection path R4 onto an outside of the printer 1000. The printer 1000 further includes an output tray 81 serving as a stacker disposed on a top face of the apparatus body 50. The recording sheet S ejected by the sheet ejection-reverse roller pair 46 is stacked on the output tray 81.

Conversely, in a case that the recording sheet S bears the toner image on one side of the recording sheet S in the duplex printing mode, when a trailing end of the recording sheet S in the sheet conveyance direction DS enters the sheet ejection nip formed by the sheet ejection-reverse roller pair 46, the sheet ejection-reverse roller pair 46 rotates backward. The printer 1000 further includes a switching claw 47 and a reverse reconveyance path R5 (e.g., a reverse passage). The switching claw 47 is disposed in proximity to a downstream end of the sheet ejection path R4 in the sheet conveyance direction DS. The switching claw 47 blocks the sheet ejection path R4 and opens an entry to the reverse reconveyance path R5. As the sheet ejection-reverse roller pair 46 rotates backward, the sheet ejection-reverse roller pair 46 starts conveying the recording sheet S backward into the reverse reconveyance path R5. The reverse reconveyance path R5 has a downstream end that adjoins an upstream end of the shared conveyance path R3, that is disposed upstream from the registration roller pair 43 in the sheet conveyance direction DS. After the recording sheet S is conveyed through the reverse reconveyance path R5, the recording sheet S is conveyed to the registration roller pair 43 in the shared conveyance path R3 again. After the transfer roller 10 transfers a toner image onto another side of the recording sheet S at the transfer nip, the recording sheet S is conveyed through the fixing device 44, the sheet ejection path R4, and the sheet ejection-reverse roller pair 46 and is ejected to the outside of the printer 1000.

The fixing device 44 serving as a unit according to the embodiment further includes a cleaning roller 44d. The cleaning roller 44d serves as a contact-separation member that comes into contact with and separates from the pressure roller 44b. The cleaning roller 44d removes a foreign substance such as toner and paper dust that adheres to a surface of the pressure roller 44b as a target with which the cleaning roller 44d comes into contact and from which the cleaning roller 44d separates. The fixing device 44 further includes a contact and separation mechanism that brings the cleaning roller 44d into contact with the pressure roller 44b and separates the cleaning roller 44d from the pressure roller 44b.

The fixing device 44 further includes components that construct the sheet ejection path R4 from the fixing nip to the switching claw 47. For example, the fixing device 44 further includes a sheet ejection guide 59, a sheet ejection-reverse guide 58, and a relay conveyance roller pair 51. The sheet ejection guide 59 includes a guide portion 59a that is disposed opposite a contact face of the recording sheet S, that contacts the fixing roller 44a at the fixing nip, after the recording sheet S passes through the fixing nip. The guide portion 59a guides the recording sheet S to the switching claw 47. The sheet ejection-reverse guide 58 is disposed opposite a contact face of the recording sheet S, that contacts the pressure roller 44b at the fixing nip, after the recording sheet S passes through the fixing nip. The sheet ejection-reverse guide 58 includes an ejection guide portion 58a and a reverse guide portion 58b. The ejection guide portion 58a guides the recording sheet S to the switching claw 47. The reverse guide portion 58b is disposed opposite an image bearing face of the recording sheet S that has passed through the switching claw 47 and is conveyed thorough the reverse reconveyance path R5. The reverse guide portion 58b guides the recording sheet S. The printer 1000 further includes a reverse conveyance roller pair 52 including a driving roller 52a and a driven roller 52b. The driven roller 52b is mounted on the sheet ejection-reverse guide 58 and conveys the recording sheet S in the reverse reconveyance path R5.

The printer 1000 further includes an open-close cover 55 and a reverse guide 57. The open-close cover 55 is disposed on a left side face of the apparatus body 50 of the printer 1000 in FIG. 1. The open-close cover 55 mounts the reverse guide 57 that is disposed opposite a blank face (e.g., a face that does not bear a toner image) of the recording sheet S conveyed through the reverse reconveyance path R5. The reverse guide 57 guides the recording sheet S. The reverse guide 57 mounts the driving roller 52a of the reverse conveyance roller pair 52.

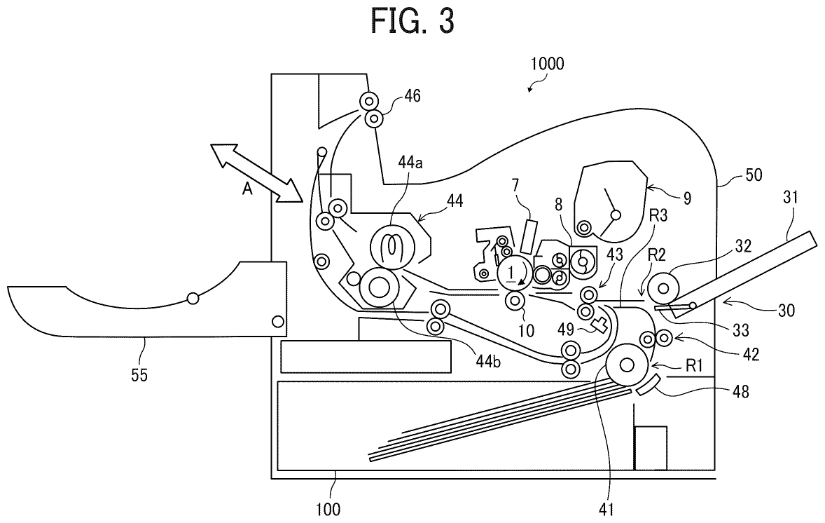

FIG. 3 is a schematic cross-sectional view of the printer 1000 in a state in which the open-close cover 55 is opened.

As the user or a service engineer opens the open-close cover 55, the fixing device 44 is exposed. Thus, the user or the service engineer removes the fixing device 44 from the apparatus body 50 of the printer 1000 and installs the fixing device 44 into the apparatus body 50 in a direction A.

A description is provided of a basic construction of a driver 60 installable in the printer 1000.

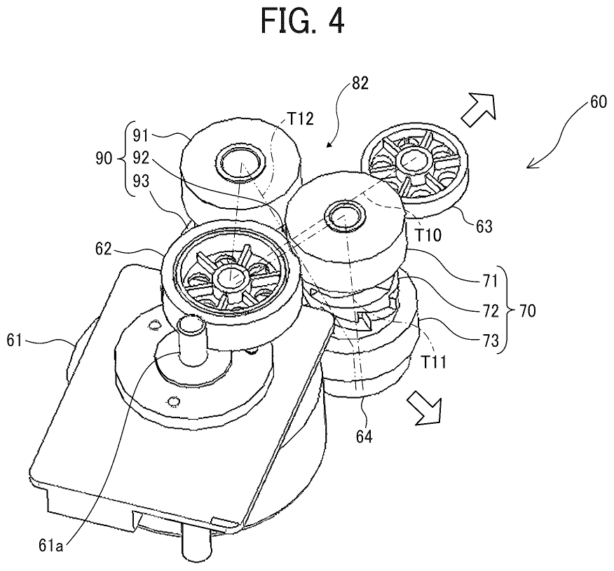

FIG. 4 is a perspective view of the driver 60, illustrating the basic construction thereof.

The driver 60 includes a driving motor 61 that generates a driving force that is transmitted to the sheet ejection-reverse roller pair 46 serving as a first rotator and the fixing roller 44a serving as a second rotator.

The driver 60 includes a driving force transmitter 82 including the driving motor 61 serving as a driving source, a motor input gear 62, a forward rotation one-way clutch device 70, a backward rotation one-way clutch device 90, a sheet ejection-reverse output gear 63, and a fixing output gear 64. The forward rotation one-way clutch device 70 transmits the driving force generated by the driving motor 61 when the driving motor 61 rotates forward. The forward rotation one-way clutch device 70 interrupts transmission of the driving force generated by the driving motor 61 when the driving motor 61 rotates backward. The backward rotation one-way clutch device 90 interrupts transmission of the driving force generated by the driving motor 61 when the driving motor 61 rotates forward. The backward rotation one-way clutch device 90 transmits the driving force generated by the driving motor 61 when the driving motor 61 rotates backward.

The driving motor 61 includes a motor shaft 61a. The forward rotation one-way clutch device 70 includes a forward rotation input gear 71, a forward rotation joint 72, and a forward rotation output gear 73. The backward rotation one-way clutch device 90 includes a backward rotation input gear 91. The motor input gear 62 meshes with a motor gear directly coupled with the motor shaft 61a of the driving motor 61, the forward rotation input gear 71 of the forward rotation one-way clutch device 70, and the backward rotation input gear 91 of the backward rotation one-way clutch device 90. The motor input gear 62 transmits the driving force generated by the driving motor 61 to the forward rotation input gear 71 and the backward rotation input gear 91.

The driver 60 further includes a forward and backward rotation driving force transmission path T10, a first forward rotation driving force transmission path T11, and a second forward rotation driving force transmission path T12. The forward and backward rotation driving force transmission path T10 transmits the driving force to a driving roller of the sheet ejection-reverse roller pair 46. The forward and backward rotation driving force transmission path T10 is constructed of the motor input gear 62, the forward rotation input gear 71, and the sheet ejection-reverse output gear 63. When the driving motor 61 rotates forward, the driving motor 61 rotates the fixing roller 44a forward through the first forward rotation driving force transmission path T11. The first forward rotation driving force transmission path T11 is constructed of the motor input gear 62, the forward rotation one-way clutch device 70, and the fixing output gear 64. When the driving motor 61 rotates backward, the driving motor 61 rotates the fixing roller 44a forward through the second forward rotation driving force transmission path T12. The second forward rotation driving force transmission path T12 is constructed of the motor input gear 62, the backward rotation one-way clutch device 90, the forward rotation output gear 73 of the forward rotation one-way clutch device 70, and the fixing output gear 64.

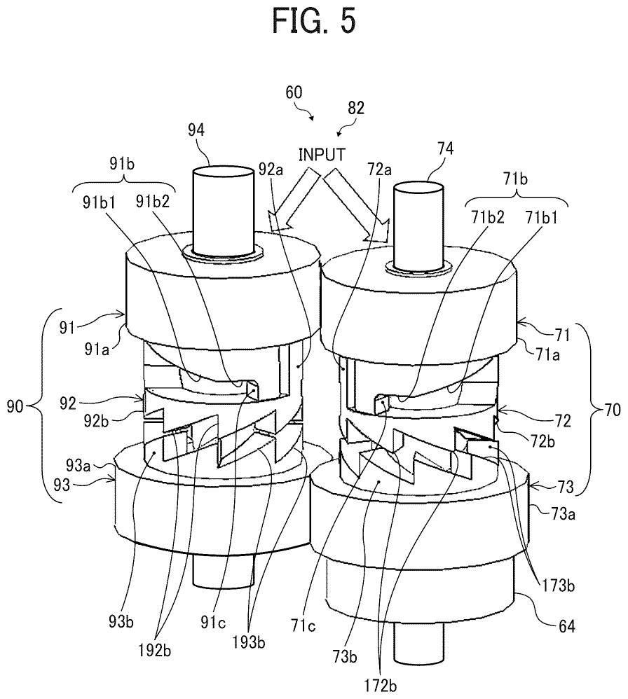

FIG. 5 is a perspective view of the forward rotation one-way clutch device 70 and the backward rotation one-way clutch device 90.

The forward rotation one-way clutch device 70 includes the forward rotation input gear 71 serving as an input member, the forward rotation joint 72 serving as a joint, and the forward rotation output gear 73 serving as an output member. The forward rotation one-way clutch device 70 further includes a first support shaft 74 that rotatably supports the forward rotation input gear 71, the forward rotation joint 72, and the forward rotation output gear 73. The first support shaft 74 supports the forward rotation joint 72 such that the forward rotation joint 72 moves between the forward rotation input gear 71 and the forward rotation output gear 73 in an axial direction of the first support shaft 74.

The forward rotation input gear 71 includes a forward rotation input gear portion 71a and a forward rotation pressing portion 71b. The forward rotation input gear portion 71a meshes with the motor input gear 62 and the sheet ejection-reverse output gear 63. The forward rotation pressing portion 71b presses the forward rotation joint 72 against the forward rotation output gear 73. The forward rotation input gear 71 further includes a forward rotation input engaging portion 71c. The forward rotation joint 72 includes a first forward rotation engaging portion 72a. The forward rotation input engaging portion 71c engages the first forward rotation engaging portion 72a. The forward rotation input gear 71 includes two forward rotation pressing portions 71b and two forward rotation input engaging portions 71c that are arranged with a spacing of 180 degrees in a rotation direction of the forward rotation input gear 71, respectively.

The forward rotation pressing portions 71b and the forward rotation input engaging portions 71c are disposed on an opposed face of the forward rotation input gear 71, that is disposed opposite the forward rotation joint 72. The forward rotation pressing portion 71b includes a slope 71b1 and a plane 71b2. The slope 71b1 is inclined such that the slope 71b1 has a height that decreases toward an upstream of the slope 71b1 in a forward rotation direction in which the forward rotation input gear 71 rotates forward (e.g., a rotation direction in which the forward rotation input gear 71 rotates when the driving motor 61 rotates forward). The plane 71b2 is perpendicular to the axial direction of the first support shaft 74. The forward rotation input engaging portion 71c projects toward the forward rotation joint 72 from a downstream end of the plane 71b2 in the forward rotation direction in which the forward rotation input gear 71 rotates forward.

The forward rotation joint 72 includes the first forward rotation engaging portion 72a and a second forward rotation engaging portion 72b. The first forward rotation engaging portion 72a projects toward the forward rotation input gear 71. The forward rotation output gear 73 includes a forward rotation output engaging portion 73b. The second forward rotation engaging portion 72b meshes with the forward rotation output engaging portion 73b. The forward rotation joint 72 includes two first forward rotation engaging portions 72a that are arranged with a spacing of 180 degrees in the rotation direction of the forward rotation input gear 71. The second forward rotation engaging portion 72b includes a plurality of projections 172b that projects toward the forward rotation output gear 73. The projections 172b are arranged in a circumferential direction of the forward rotation joint 72. Each of the projections 172b includes a plane and a slope. The plane is perpendicular to the circumferential direction of the forward rotation joint 72. The slope has a height that decreases toward an upstream of the projection 172b in a rotation direction of the forward rotation joint 72 when the driving force is transmitted. That is, an amount of projection of the slope that projects toward the forward rotation output gear 73 decreases. The projection 172b has a right-angled triangle shape when seen in a radial direction of the forward rotation joint 72.

The forward rotation output gear 73 defines a two-stage gear constructed of a forward rotation output gear portion 73a and the fixing output gear 64. The backward rotation one-way clutch device 90 further includes a backward rotation output gear 93 including a backward rotation output gear portion 93a. The forward rotation output gear portion 73a meshes with the backward rotation output gear portion 93a. The forward rotation output gear 73 includes the forward rotation output engaging portion 73b that meshes with the second forward rotation engaging portion 72b of the forward rotation joint 72. The forward rotation output engaging portion 73b includes a plurality of projections 173b that projects toward the forward rotation joint 72. The projections 173b are arranged in a circumferential direction of the forward rotation output gear 73. Each of the projections 173b has a right-angled triangle shape where the projection 172b of the second forward rotation engaging portion 72b is laterally inverted when seen in a radial direction of the forward rotation output gear 73. For example, each of the projections 173b includes a plane and a slope. The plane is perpendicular to the circumferential direction of the forward rotation output gear 73. The slope has a height that decreases toward a downstream of the projection 173b in a rotation direction of the forward rotation output gear 73 when the driving force is transmitted. That is, an amount of projection of the slope that projects toward the forward rotation joint 72 decreases.

The backward rotation one-way clutch device 90 further includes a backward rotation joint 92 and a second support shaft 94. The backward rotation input gear 91 serves as an input member. The backward rotation joint 92 serves as a joint. The backward rotation output gear 93 serves as an output member. The second support shaft 94 rotatably supports the backward rotation input gear 91, the backward rotation joint 92, and the backward rotation output gear 93. The second support shaft 94 supports the backward rotation joint 92 such that the backward rotation joint 92 moves between the backward rotation input gear 91 and the backward rotation output gear 93 in an axial direction of the second support shaft 94.

The backward rotation input gear 91 includes a backward rotation input gear portion 91a, a backward rotation pressing portion 91b, and a backward rotation input engaging portion 91c. The backward rotation input gear portion 91a meshes with the motor input gear 62. The backward rotation pressing portion 91b presses the backward rotation joint 92 against the backward rotation output gear 93. The backward rotation joint 92 includes a first backward rotation engaging portion 92a. The backward rotation input engaging portion 91c engages the first backward rotation engaging portion 92a.

The backward rotation pressing portion 91b and the backward rotation input engaging portion 91c are disposed on an opposed face of the backward rotation input gear 91, that is disposed opposite the backward rotation joint 92. The backward rotation pressing portion 91b includes a slope 91b1 and a plane 91b2. The slope 91b1 is inclined such that the slope 91b1 has a height that decreases toward an upstream of the slope 91b1 in a backward rotation direction in which the backward rotation input gear 91 rotates backward (e.g., a rotation direction in which the backward rotation input gear 91 rotates when the driving motor 61 rotates backward). The plane 91b2 is perpendicular to the axial direction of the second support shaft 94. The backward rotation input engaging portion 91c projects toward the backward rotation joint 92 from a downstream end of the plane 91b2 in the backward rotation direction in which the backward rotation input gear 91 rotates backward.

The backward rotation joint 92 includes the first backward rotation engaging portion 92a and a second backward rotation engaging portion 92b. The first backward rotation engaging portion 92a projects toward the backward rotation input gear 91. The backward rotation output gear 93 includes a backward rotation output engaging portion 93b. The second backward rotation engaging portion 92b meshes with the backward rotation output engaging portion 93b. The second backward rotation engaging portion 92b includes a plurality of projections 192b that projects toward the backward rotation output gear 93. The projections 192b are arranged in a circumferential direction of the backward rotation joint 92. Each of the projections 192b has a right-angled triangle shape where the projection 172b of the second forward rotation engaging portion 72b is laterally inverted when each of the projections 192b is seen in a radial direction of the backward rotation joint 92.

The backward rotation output gear 93 includes the backward rotation output gear portion 93a and the backward rotation output engaging portion 93b. The backward rotation output gear portion 93a meshes with the forward rotation output gear portion 73a of the forward rotation output gear 73. The backward rotation output engaging portion 93b meshes with the second backward rotation engaging portion 92b of the backward rotation joint 92. The backward rotation output engaging portion 93b includes a plurality of projections 193b that projects toward the backward rotation joint 92. The projections 193b are arranged in a circumferential direction of the backward rotation output gear 93. Each of the projections 193b has a right-angled triangle shape where the projection 192b of the second backward rotation engaging portion 92b is laterally inverted when each of the projections 193b is seen in a radial direction of the backward rotation output gear 93.

The following describes the components of the forward rotation one-way clutch device 70 and the components of the backward rotation one-way clutch device 90 by omitting the terms of forward rotation and backward rotation unless the components of the forward rotation one-way clutch device 70 are not distinguished from the components of the backward rotation one-way clutch device 90 with the terms of forward rotation and backward rotation.

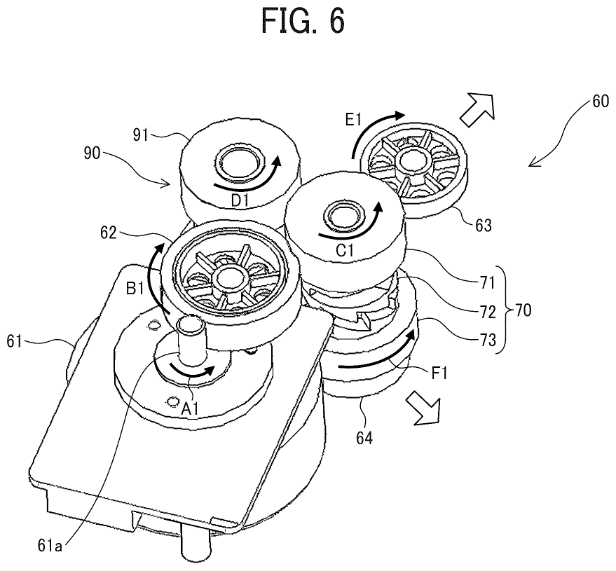

FIG. 6 is a perspective view of the driver 60, illustrating the basic construction thereof that transmits the driving force when the driving motor 61 rotates forward.

As illustrated in FIG. 6, when the driving motor 61 rotates forward, the motor shaft 61a rotates in a direction A1. The motor input gear 62 rotates in a direction B1. The forward rotation input gear 71 of the forward rotation one-way clutch device 70 rotates in a direction C1. The backward rotation input gear 91 of the backward rotation one-way clutch device 90 rotates in a direction D1. As the forward rotation input gear 71 rotates in the direction C1, the sheet ejection-reverse output gear 63 meshing with the forward rotation input gear 71 rotates in a direction E1. The sheet ejection-reverse output gear 63 drives and rotates the sheet ejection-reverse roller pair 46 coupled with the sheet ejection-reverse output gear 63 forward to eject the recording sheet S from the sheet ejection path R4 onto the outside of the printer 1000.

As the forward rotation input gear 71 rotates in the direction C1, the forward rotation joint 72 meshes with the forward rotation output gear 73. Accordingly, the driving force transmitted to the forward rotation input gear 71 is transmitted to the forward rotation output gear 73 through the forward rotation joint 72, rotating the forward rotation output gear 73 in a direction F1. The fixing output gear 64 combined with the forward rotation output gear 73 rotates together with the forward rotation output gear 73, driving and rotating the fixing roller 44a coupled with the fixing output gear 64 forward.

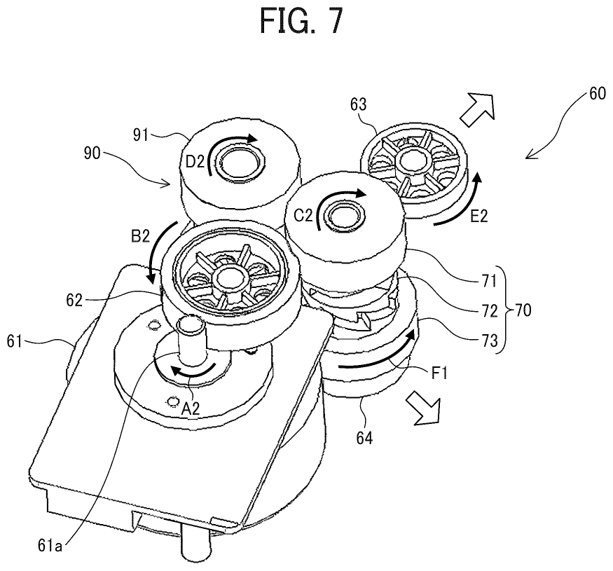

FIG. 7 is a perspective view of the driver 60, illustrating transmission of the driving force when the driving motor 61 rotates backward.

As illustrated in FIG. 7, when the driving motor 61 rotates backward, the motor shaft 61a rotates in a direction A2 opposite to the direction A1 depicted in FIG. 6. The motor input gear 62 rotates in a direction B2 opposite to the direction B1 depicted in FIG. 6. The forward rotation input gear 71 of the forward rotation one-way clutch device 70 rotates in a direction C2 opposite to the direction C1 depicted in FIG. 6. The backward rotation input gear 91 of the backward rotation one-way clutch device 90 rotates in a direction D2 opposite to the direction D1 depicted in FIG. 6. As the forward rotation input gear 71 rotates in the direction C2, the sheet ejection-reverse output gear 63 meshing with the forward rotation input gear 71 rotates in a direction E2 opposite to the direction E1 depicted in FIG. 6. The sheet ejection-reverse output gear 63 drives and rotates the sheet ejection-reverse roller pair 46 backward. Thus, the sheet ejection-reverse roller pair 46 conveys the recording sheet S from the sheet ejection path R4 into the reverse reconveyance path R5.

As the backward rotation input gear 91 rotates in the direction D2, the backward rotation joint 92 meshes with the backward rotation output gear 93. The driving force transmitted to the backward rotation input gear 91 is transmitted to the backward rotation output gear 93 through the backward rotation joint 92, rotating the backward rotation output gear 93. Accordingly, the forward rotation output gear 73 meshing with the backward rotation output gear 93 rotates in the direction F1 identical to the direction F1 depicted in FIG. 6. Consequently, the fixing output gear 64 combined with the forward rotation output gear 73 rotates together with the forward rotation output gear 73 in a direction (e.g., the direction F1) identical to a direction (e.g., the direction F1) in which the fixing output gear 64 rotates in FIG. 6, driving and rotating the fixing roller 44a forward.

As described above, when the driving motor 61 rotates forward, the driving motor 61 drives and rotates the sheet ejection-reverse roller pair 46 forward. When the driving motor 61 rotates backward, the driving motor 61 drives and rotates the sheet ejection-reverse roller pair 46 backward. Conversely, when the driving motor 61 rotates forward and when the driving motor 61 rotates backward, the driving motor 61 drives and rotates the fixing roller 44a forward. Accordingly, the single driving motor 61 drives a rotator (e.g., the fixing roller 44a) that is driven and rotated forward constantly and a rotator (e.g., the sheet ejection-reverse roller pair 46) that is driven and rotated forward and backward.

A description is provided of operations of the forward rotation one-way clutch device 70.

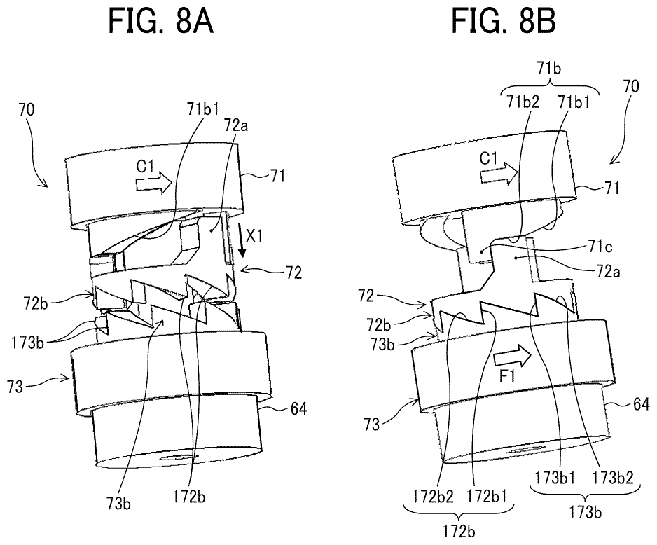

FIGS. 8A and 8B illustrate diagrams, respectively, of the forward rotation one-way clutch device 70, illustrating the operations thereof when the driving motor 61 rotates forward.

As the motor input gear 62 transmits a driving force generated by the driving motor 61 to the forward rotation input gear 71 depicted in FIG. 8A, the forward rotation input gear 71 rotates in the direction C1. Accordingly, a tip of the first forward rotation engaging portion 72a of the forward rotation joint 72 contacts the slope 71b1 of the forward rotation pressing portion 71b. As the forward rotation input gear 71 rotates, the slope 71b1 presses the first forward rotation engaging portion 72a against the forward rotation output gear 73. Accordingly, the forward rotation joint 72 moves toward the forward rotation output gear 73 in a direction X1.

As the tip of the first forward rotation engaging portion 72a climbs the slope 71b1 and reaches the plane 71b2 of the forward rotation pressing portion 71b, as illustrated in FIG. 8B, the forward rotation input engaging portion 71c comes into contact with the first forward rotation engaging portion 72a of the forward rotation joint 72 in the direction C1. Accordingly, the forward rotation input engaging portion 71c engages the first forward rotation engaging portion 72a. The forward rotation joint 72 rotates together with the forward rotation input gear 71.

The second forward rotation engaging portion 72b of the forward rotation joint 72 meshes with the forward rotation output engaging portion 73b of the forward rotation output gear 73. The forward rotation output gear 73 rotates together with the forward rotation joint 72 in the direction F1. Accordingly, the fixing output gear 64 combined with the forward rotation output gear 73 rotates together with the forward rotation output gear 73, driving and rotating the fixing roller 44a forward.

When the driving motor 61 rotates backward, the forward rotation one-way clutch device 70 transits from a state depicted in FIG. 8B to a state depicted in FIG. 8A as described below, interrupting transmission of the driving force to the forward rotation output gear 73. For example, the forward rotation input gear 71 rotates in a direction opposite to the direction C1 from the state depicted in FIG. 8B, releasing contact of the first forward rotation engaging portion 72a of the forward rotation joint 72 with the plane 71b2 of the forward rotation pressing portion 71b in the axial direction of the first support shaft 74. Accordingly, a clearance generates between the first forward rotation engaging portion 72a and the forward rotation pressing portion 71b in the axial direction of the first support shaft 74. Hence, the forward rotation joint 72 is movable toward the forward rotation input gear 71.

As the forward rotation input gear 71 rotates 180 degrees, the forward rotation input engaging portion 71c comes into contact with the first forward rotation engaging portion 72a in the direction opposite to the direction C1, rotating the forward rotation joint 72 in the direction opposite to the direction C1. On the other hand, the forward rotation output gear 73 receives the driving force from the backward rotation output gear 93 and rotates in the direction F1. Accordingly, a slope 173b2 of the projection 173b of the forward rotation output engaging portion 73b of the forward rotation output gear 73 presses the second forward rotation engaging portion 72b of the forward rotation joint 72 against the forward rotation input gear 71. As described above, the forward rotation joint 72 is spaced from the forward rotation pressing portion 71b and is movable toward the forward rotation input gear 71. Hence, the slope 173b2 of the projection 173b of the forward rotation output engaging portion 73b presses and moves the forward rotation joint 72 toward the forward rotation input gear 71 as illustrated in FIG. 8A. Accordingly, meshing of the second forward rotation engaging portion 72b of the forward rotation joint 72 with the forward rotation output engaging portion 73b of the forward rotation output gear 73 is released. Consequently, transmission of the driving force is interrupted.

A description is provided of operations of the backward rotation one-way clutch device 90.

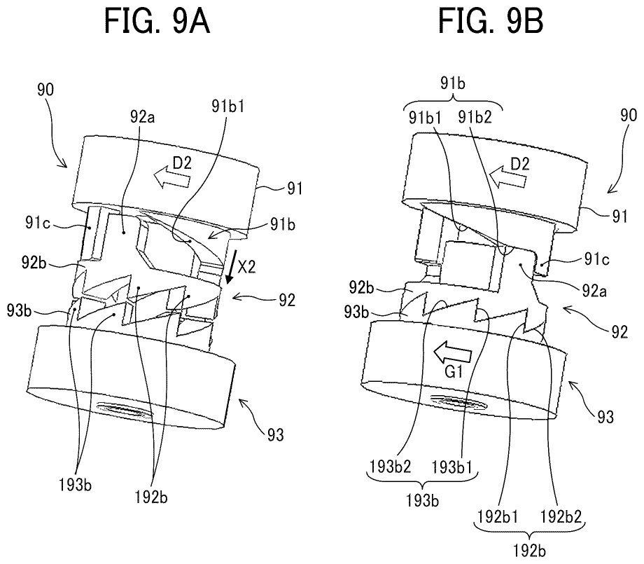

FIGS. 9A and 9B illustrate diagrams, respectively, of the backward rotation one-way clutch device 90, illustrating the operations thereof when the driving motor 61 rotates backward.

As the motor input gear 62 transmits a driving force generated by the driving motor 61 to the backward rotation input gear 91 depicted in FIG. 9A, the backward rotation input gear 91 rotates in the direction D2. Accordingly, a tip of the first backward rotation engaging portion 92a of the backward rotation joint 92 contacts the slope 91b1 of the backward rotation pressing portion 91b. As the backward rotation input gear 91 rotates, the slope 91b1 presses the first backward rotation engaging portion 92a against the backward rotation output gear 93. Accordingly, the backward rotation joint 92 moves toward the backward rotation output gear 93 in a direction X2.

As the tip of the first backward rotation engaging portion 92a climbs the slope 91b1 and reaches the plane 91b2 of the backward rotation pressing portion 91b, as illustrated in FIG. 9B, the backward rotation input engaging portion 91c comes into contact with the first backward rotation engaging portion 92a of the backward rotation joint 92 in the direction D2. Accordingly, the backward rotation input engaging portion 91c engages the first backward rotation engaging portion 92a. The backward rotation joint 92 rotates together with the backward rotation input gear 91. The second backward rotation engaging portion 92b of the backward rotation joint 92 meshes with the backward rotation output engaging portion 93b of the backward rotation output gear 93. The backward rotation output gear 93 rotates together with the backward rotation joint 92 in a direction G1.

When the driving motor 61 rotates forward, the backward rotation one-way clutch device 90 interrupts transmission of the driving force to the backward rotation output gear 93, like the forward rotation one-way clutch device 70. For example, when the driving motor 61 rotates forward, the backward rotation input gear 91 rotates in a direction opposite to the direction D2 depicted in FIG. 9B. The backward rotation joint 92 is spaced from the backward rotation pressing portion 91b and is movable toward the backward rotation input gear 91. As the backward rotation input gear 91 rotates 180 degrees in the direction opposite to the direction D2, the backward rotation input engaging portion 91c comes into contact with the first backward rotation engaging portion 92a in the direction opposite to the direction D2, rotating the backward rotation joint 92 in the direction opposite to the direction D2.

On the other hand, the backward rotation output gear 93 receives the driving force from the forward rotation output gear 73 and rotates in the direction G1. Accordingly, a slope 193b2 of the projection 193b of the backward rotation output engaging portion 93b of the backward rotation output gear 93 presses the second backward rotation engaging portion 92b of the backward rotation joint 92 against the backward rotation input gear 91. Consequently, the backward rotation joint 92 moves toward the backward rotation input gear 91 as illustrated in FIG. 9A. Accordingly, meshing of the second backward rotation engaging portion 92b of the backward rotation joint 92 with the backward rotation output engaging portion 93b of the backward rotation output gear 93 is released. Consequently, transmission of the driving force is interrupted.

A description is provided of an advantageous construction of a driver 60A according to an embodiment of the present disclosure, that is installed in the printer 1000 depicted in FIG. 1.

As illustrated in FIGS. 8A, 8B, 9A, and 9B, the driver 60 having the basic construction described above includes the forward rotation one-way clutch device 70 and the backward rotation one-way clutch device 90. The forward rotation one-way clutch device 70 includes the forward rotation joint 72 serving as the joint including the second forward rotation engaging portion 72b serving as a second engaging portion including the projections 172b and the forward rotation output gear 73 serving as the output member including the forward rotation output engaging portion 73b serving as an output engaging portion including the projections 173b. The backward rotation one-way clutch device 90 includes the backward rotation joint 92 serving as the joint including the second backward rotation engaging portion 92b serving as a second engaging portion including the projections 192b and the backward rotation output gear 93 serving as the output member including the backward rotation output engaging portion 93b serving as an output engaging portion including the projections 193b. Each of the projections 172b, 173b, 192b, and 193b serves as a projection that includes a plane and a slope.

For example, the projection 172b includes a plane 172b1 and a slope 172b2. The projection 173b includes a plane 173b1 and the slope 173b2. The projection 192b includes a plane 192b1 and a slope 192b2. The projection 193b includes a plane 193b1 and the slope 193b2. The plane is perpendicular to the circumferential direction of each of the forward rotation joint 72, the forward rotation output gear 73, the backward rotation joint 92, and the backward rotation output gear 93. The slope has a height (e.g., an amount of projection) that decreases as the slope separates from a tip of the projection.

Each of the projections 172b, 173b, 192b, and 193b has a right-angled triangle shape when seen in the radial direction of the forward rotation joint 72, the forward rotation output gear 73, the backward rotation joint 92, and the backward rotation output gear 93. As illustrated in FIGS. 8A, 8B, 9A, and 9B, the right-angled triangle shape of the projection 192b of the second backward rotation engaging portion 92b is laterally inverted with respect to the right-angled triangle shape of the projection 172b of the second forward rotation engaging portion 72b. The right-angled triangle shape of the projection 193b of the backward rotation output engaging portion 93b is laterally inverted with respect to the right-angled triangle shape of the projection 173b of the forward rotation output engaging portion 73b.

The forward rotation pressing portion 71b of the forward rotation input gear 71 is also laterally inverted with respect to the backward rotation pressing portion 91b of the backward rotation input gear 91.

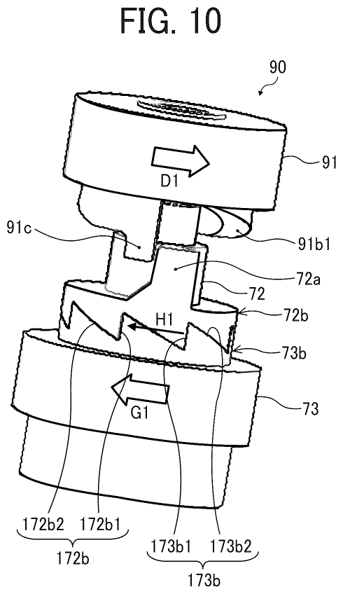

FIG. 10 is a perspective view of the backward rotation one-way clutch device 90 attached with the forward rotation joint 72 and the forward rotation output gear 73 depicted in FIG. 7.

As described above, as the driving motor 61 rotates forward, the backward rotation input engaging portion 91c comes into contact with the first forward rotation engaging portion 72a of the forward rotation joint 72 in a direction opposite to a direction to transmit a driving force. The forward rotation output gear 73 attached to the backward rotation one-way clutch device 90 receives the driving force from the forward rotation one-way clutch device 70 and rotates in the direction G1. The plane 173b1 of the projection 173b of the forward rotation output engaging portion 73b of the forward rotation output gear 73, that is perpendicular to the circumferential direction of the forward rotation output gear 73, presses the second forward rotation engaging portion 72b of the forward rotation joint 72 attached to the backward rotation one-way clutch device 90 in a direction H1, that is, the circumferential direction of the forward rotation output gear 73. Hence, the forward rotation output gear 73 attached to the backward rotation one-way clutch device 90 does not move to the backward rotation input gear 91. Accordingly, meshing of the second forward rotation engaging portion 72b with the forward rotation output engaging portion 73b is not released and therefore transmission of the driving force is not interrupted.

To address the circumstance, in the driver 60 having the basic construction, the components of the forward rotation one-way clutch device 70 (e.g., the forward rotation input gear 71, the forward rotation joint 72, and the forward rotation output gear 73) are shaped differently from the components of the backward rotation one-way clutch device 90 (e.g., the backward rotation input gear 91, the backward rotation joint 92, and the backward rotation output gear 93).

However, the components of the forward rotation one-way clutch device 70 and the components of the backward rotation one-way clutch device 90 are manufactured with different molds, respectively, increasing manufacturing costs of the molds. The forward rotation joint 72 and the backward rotation joint 92 are different from each other in a shape of the second engaging portion (e.g., the second forward rotation engaging portion 72b and the second backward rotation engaging portion 92b), causing assembly errors. Hence, the forward rotation joint 72 is to differ from the backward rotation joint 92 in color, for example.

To address the circumstances, the driver 60A according to an embodiment of the present disclosure includes a forward rotation one-way clutch device 70A and a backward rotation one-way clutch device 90A that employ a compatible joint as described below.

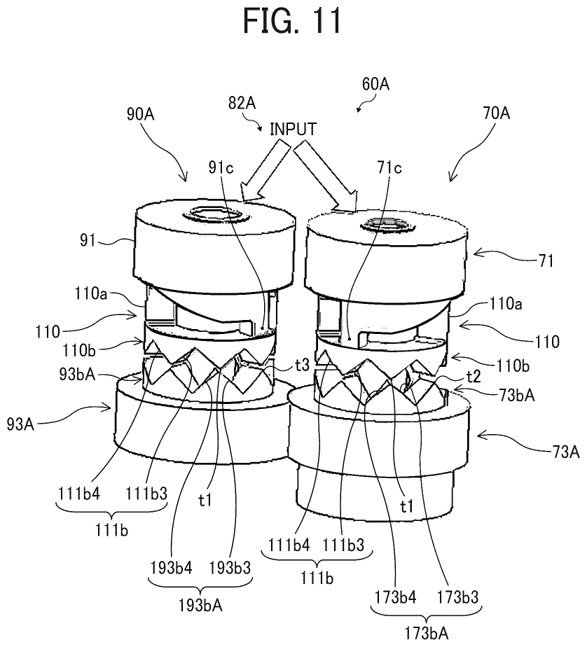

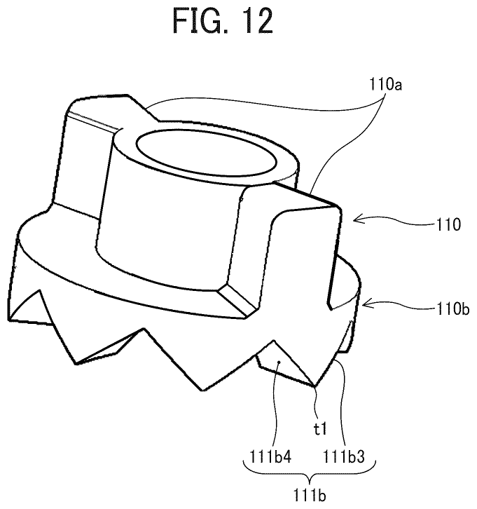

FIG. 11 is a perspective view of the driver 60A including a driving force transmitter 82A that includes the forward rotation one-way clutch device 70A and the backward rotation one-way clutch device 90A according to the embodiment. The driving force transmitter 82A further includes the driving motor 61, the motor input gear 62, the sheet ejection-reverse output gear 63, and the fixing output gear 64 depicted in FIG. 4. FIG. 12 is a perspective view of a compatible joint 110 employed by the forward rotation one-way clutch device 70A and the backward rotation one-way clutch device 90A.

According to the embodiment, as illustrated in FIG. 12, the compatible joint 110 employed by the forward rotation one-way clutch device 70A and the backward rotation one-way clutch device 90A includes a second engaging portion 110b including a plurality of projections 111b that is shaped as below. For example, the projection 111b includes a first slope 111b3 and a second slope 111b4. The first slope 111b3 has a height that decreases gradually in one direction. The second slope 111b4 has a height that decreases gradually from a tip t1 of the projection 111b in a direction opposite to the one direction. The projection 111b has an isosceles triangle shape when seen in a radial direction of the compatible joint 110.

As illustrated in FIG. 11, each of the forward rotation one-way clutch device 70A and the backward rotation one-way clutch device 90A includes an output gear including an output engaging portion including a projection that has a shape similar to a shape of the projection 111b of the compatible joint 110. For example, the forward rotation one-way clutch device 70A includes a forward rotation output gear 73A including a projection 173bA including a first slope 173b3 and a second slope 173b4. The backward rotation one-way clutch device 90A includes a backward rotation output gear 93A including a projection 193bA including a first slope 193b3 and a second slope 193b4. Each of the first slopes 173b3 and 193b3 has a height that decreases gradually in one direction. The second slopes 173b4 and 193b4 have heights that decrease gradually from a tip t2 of the projection 173bA and a tip t3 of the projection 193bA, respectively, in a direction opposite to the one direction. Each of the projections 173bA and 193bA has an isosceles triangle shape when seen in a radial direction of the forward rotation output gear 73A and the backward rotation output gear 93A.

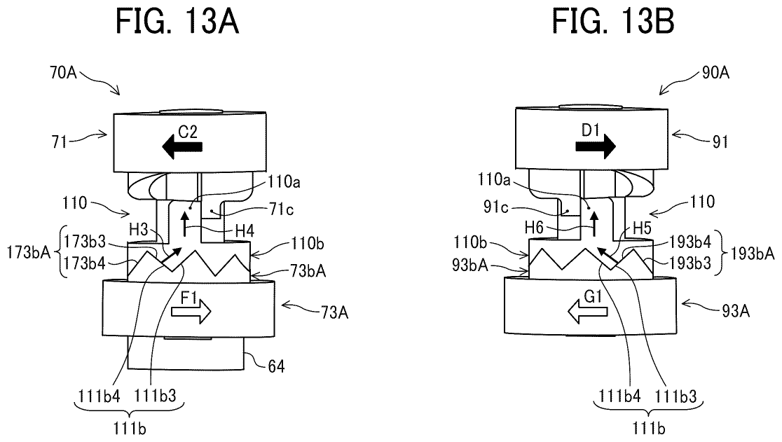

FIG. 13A is a diagram of the forward rotation one-way clutch device 70A according to the embodiment, illustrating operations thereof when the driving motor 61 rotates backward. As illustrated in FIG. 13A, the forward rotation one-way clutch device 70A includes the compatible joint 110 including a first engaging portion 110a and the forward rotation output gear 73A including a forward rotation output engaging portion 73bA.

As the driving motor 61 rotates backward, the forward rotation input engaging portion 71c comes into contact with the first engaging portion 110a of the compatible joint 110 in a direction opposite to a direction to transmit a driving force, that is, a direction C2. The forward rotation output gear 73A receives the driving force from the backward rotation output gear 93A and rotates in the direction F1. The first slope 173b3 of the projection 173bA of the forward rotation output engaging portion 73bA of the forward rotation output gear 73A presses the second slope 111b4 of the projection 111b of the second engaging portion 110b of the compatible joint 110 in a direction H3. As the first slope 173b3 presses the second slope 111b4 in the direction H3, the compatible joint 110 moves toward the forward rotation input gear 71 in a direction H4, releasing meshing of the second engaging portion 110b with the forward rotation output engaging portion 73bA and interrupting transmission of the driving force.

FIG. 13B is a diagram of the backward rotation one-way clutch device 90A according to the embodiment, illustrating operations thereof when the driving motor 61 rotates forward. As illustrated in FIG. 13B, the backward rotation one-way clutch device 90A includes the backward rotation output gear 93A including a backward rotation output engaging portion 93bA.

As the driving motor 61 rotates forward, the backward rotation input engaging portion 91c comes into contact with the first engaging portion 110a of the compatible joint 110 in a direction opposite to a direction to transmit a driving force. The backward rotation output gear 93A receives the driving force from the forward rotation output gear 73A and rotates in the direction G1. The second slope 193b4 of the projection 193bA of the backward rotation output engaging portion 93bA of the backward rotation output gear 93A presses the first slope 111b3 of the projection 111b of the second engaging portion 110b of the compatible joint 110 in a direction H5. As the second slope 193b4 presses the first slope 111b3 in the direction H5, the compatible joint 110 moves toward the backward rotation input gear 91 in a direction H6, releasing meshing of the second engaging portion 110b with the backward rotation output engaging portion 93bA and interrupting transmission of the driving force.

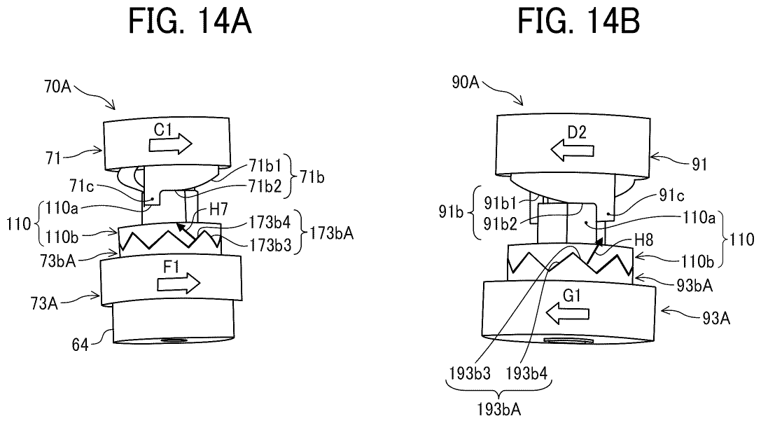

FIG. 14A is a diagram of the forward rotation one-way clutch device 70A according to the embodiment, illustrating operations thereof when the driving motor 61 rotates forward.

As illustrated in FIG. 14A, when the driving motor 61 rotates forward, the second slope 173b4 of the projection 173bA of the forward rotation output engaging portion 73bA presses the compatible joint 110 in a direction H7 by a reaction force of the forward rotation output gear 73A. However, when the driving motor 61 rotates forward, the plane 71b2 of the forward rotation pressing portion 71b restricts movement of the compatible joint 110 toward the forward rotation input gear 71. Hence, even if the second slope 173b4 of the projection 173bA presses the compatible joint 110 against the forward rotation input gear 71, the compatible joint 110 does not move toward the forward rotation input gear 71. Accordingly, the forward rotation one-way clutch device 70A retains meshing of the second engaging portion 110b with the forward rotation output engaging portion 73bA, transmitting the driving force properly.

FIG. 14B is a diagram of the backward rotation one-way clutch device 90A according to the embodiment, illustrating operations thereof when the driving motor 61 rotates backward.

As illustrated in FIG. 14B, when the driving motor 61 rotates backward, the first slope 193b3 of the projection 193bA of the backward rotation output engaging portion 93bA presses the compatible joint 110 in a direction H8 by a reaction force of the backward rotation output gear 93A. However, when the driving motor 61 rotates backward, the plane 91b2 of the backward rotation pressing portion 91b restricts movement of the compatible joint 110 toward the backward rotation input gear 91. Hence, even if the first slope 193b3 of the projection 193bA presses the compatible joint 110 against the backward rotation input gear 91, the compatible joint 110 does not move toward the backward rotation input gear 91. Accordingly, the backward rotation one-way clutch device 90A retains meshing of the second engaging portion 110b with the backward rotation output engaging portion 93bA, transmitting the driving force properly.

As described above, according to the embodiment, a joint includes a second engaging portion including a projection. An output gear includes an output engaging portion including a projection. Each of the projections includes a first slope and a second slope. The first slope has a height that decreases gradually in one direction. The second slope has a height that decreases gradually from a tip of the projection in a direction opposite to the one direction. Each of the projections has an isosceles triangle shape when seen in a radial direction of the joint and the output gear. Accordingly, even if the forward rotation one-way clutch device 70A and the backward rotation one-way clutch device 90A employ the compatible joints 110, respectively, the forward rotation one-way clutch device 70A and the backward rotation one-way clutch device 90A perform transmission and interruption of transmission of a driving force properly.

The forward rotation one-way clutch device 70A and the backward rotation one-way clutch device 90A employ the compatible joints 110, respectively, reducing manufacturing costs of the molds and the driver 60A. Additionally, since the forward rotation one-way clutch device 70A and the backward rotation one-way clutch device 90A employ the compatible joints 110, respectively, the forward rotation one-way clutch device 70A and the backward rotation one-way clutch device 90A are not assembled erroneously with improper joints, respectively.

Alternatively, the forward rotation output gear 73A and the backward rotation output gear 93A may be replaced with compatible output gears, respectively. For example, a compatible output gear combined with the fixing output gear 64 may be replaced with each of the forward rotation output gear 73A and the backward rotation output gear 93A.

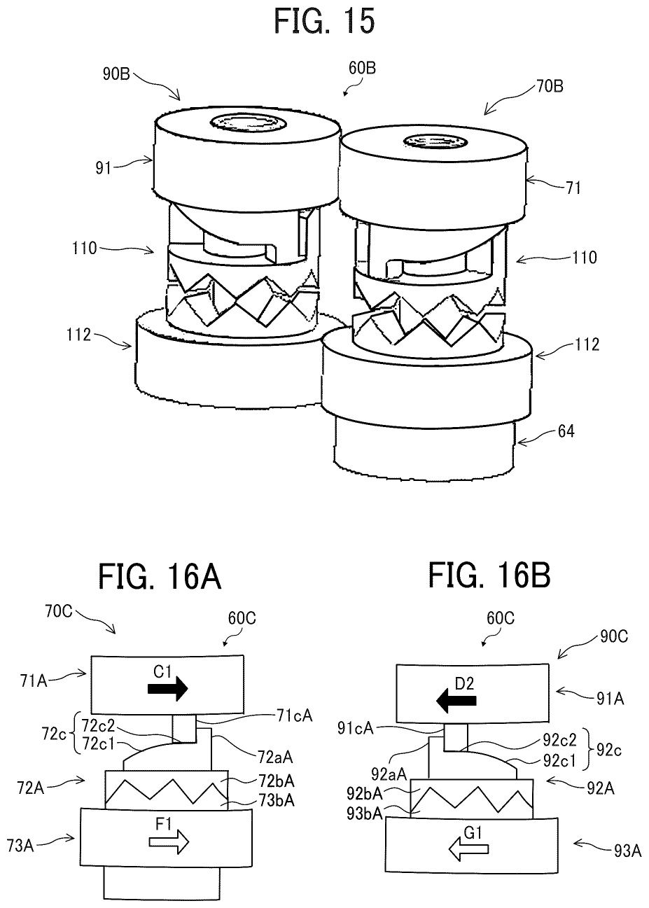

FIG. 15 illustrates a driver 60B including a forward rotation one-way clutch device 70B and a backward rotation one-way clutch device 90B. Each of the forward rotation one-way clutch device 70B and the backward rotation one-way clutch device 90B includes a compatible output gear 112. The forward rotation one-way clutch device 70B includes the fixing output gear 64 as a separate member that is attached to the compatible output gear 112. In a case that the forward rotation one-way clutch device 70B and the backward rotation one-way clutch device 90B employ compatible output gears (e.g., the compatible output gears 112), respectively, each of the compatible output gears includes a gear portion including a spur gear. Thus, the forward rotation one-way clutch device 70B and the backward rotation one-way clutch device 90B employ the compatible output gears 112, respectively, further reducing manufacturing costs of the molds and the driver 60B.

FIG. 16A illustrates a construction of a driver 60C including a forward rotation one-way clutch device 70C that includes a forward rotation input gear 71A, a forward rotation joint 72A, and the forward rotation output gear 73A. FIG. 16B illustrates a construction of the driver 60C including a backward rotation one-way clutch device 90C that includes a backward rotation input gear 91A, a backward rotation joint 92A, and the backward rotation output gear 93A.

The forward rotation joint 72A and the backward rotation joint 92A include a second forward rotation engaging portion 72bA and a second backward rotation engaging portion 92bA, respectively, that are equivalent to the second engaging portion 110b. The forward rotation joint 72A has a shape that is similar to a shape of the forward rotation pressing portion 71b constructed of the slope 71b1 and the plane 71b2 of the forward rotation input gear 71 depicted in FIG. 8B. The backward rotation joint 92A has a shape that is similar to a shape of the backward rotation pressing portion 91b constructed of the slope 91b1 and the plane 91b2 of the backward rotation input gear 91 depicted in FIG. 9B. For example, as illustrated in FIG. 16A, the forward rotation input gear 71A has an opposed face that is disposed opposite the forward rotation joint 72A. A forward rotation input engaging portion 71cA is disposed on the opposed face. As illustrated in FIG. 16B, the backward rotation input gear 91A has an opposed face that is disposed opposite the backward rotation joint 92A. A backward rotation input engaging portion 91cA is disposed on the opposed face. The forward rotation joint 72A includes a pressed portion 72c including a slope 72c1 and a plane 72c2. When a driving force is transmitted, the forward rotation input engaging portion 71cA presses the pressed portion 72c against the forward rotation output gear 73A. The backward rotation joint 92A includes a pressed portion 92c including a slope 92c1 and a plane 92c2. When a driving force is transmitted, the backward rotation input engaging portion 91cA presses the pressed portion 92c against the backward rotation output gear 93A.

With the above-described constructions of the forward rotation one-way clutch device 70C and the backward rotation one-way clutch device 90C also, when a driving force is transmitted, tips of the forward rotation input engaging portion 71cA and the backward rotation input engaging portion 91cA climb the slopes 72c1 and 92c1, respectively. Accordingly, the forward rotation joint 72A and the backward rotation joint 92A gradually move toward the forward rotation output gear 73A and the backward rotation output gear 93A, respectively. Consequently, the second engaging portion (e.g., the second forward rotation engaging portion 72bA and the second backward rotation engaging portion 92bA) of the forward rotation joint 72A and the backward rotation joint 92A meshes with an output engaging portion (e.g., the forward rotation output engaging portion 73bA and the backward rotation output engaging portion 93bA) of an output gear (e.g., the forward rotation output gear 73A and the backward rotation output gear 93A). When the forward rotation input engaging portion 71cA and the backward rotation input engaging portion 91cA come into contact with a first forward rotation engaging portion 72aA and a first backward rotation engaging portion 92aA of the forward rotation joint 72A and the backward rotation joint 92A, respectively, to transmit a driving force, the planes 72c2 and 92c2 of the pressed portions 72c and 92c come into contact with the tips of the forward rotation input engaging portion 71cA and the backward rotation input engaging portion 91cA, respectively, thus restricting movement of the forward rotation joint 72A and the backward rotation joint 92A toward the forward rotation input gear 71A and the backward rotation input gear 91A.

With the constructions of the forward rotation one-way clutch device 70C and the backward rotation one-way clutch device 90C depicted in FIGS. 16A and 16B, respectively, the forward rotation one-way clutch device 70C and the backward rotation one-way clutch device 90C employ compatible input gears (e.g., the forward rotation input gear 71A and the backward rotation input gear 91A) and compatible output gears (e.g., the forward rotation output gear 73A and the backward rotation output gear 93A), respectively.

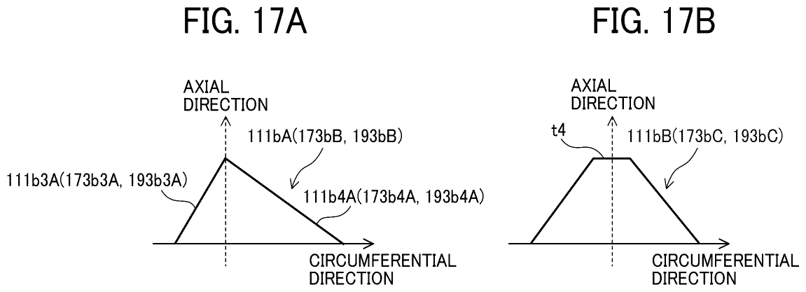

As described above with reference to FIG. 11, when the projection 111b of the second engaging portion 110b of the compatible joint 110, the projection 173bA of the forward rotation output engaging portion 73bA of the forward rotation output gear 73A, and the projection 193bA of the backward rotation output engaging portion 93bA of the backward rotation output gear 93A are seen in the radial direction of the compatible joint 110, the forward rotation output gear 73A, and the backward rotation output gear 93A, each of the projections 111b, 173bA, and 193bA has the isosceles triangle shape. A first slope (e.g., the first slopes 111b3, 173b3, and 193b3) and a second slope (e.g., the second slopes 111b4, 173b4, and 193b4) have an identical angle of inclination. Alternatively, as illustrated in FIG. 17A, the first slope and the second slope may have different angles of inclination, respectively.

FIG. 17A illustrates projections 111bA, 173bB, and 193bB including the first slope (e.g., first slopes 111b3A, 173b3A, and 193b3A) and the second slope (e.g., second slopes 111b4A, 173b4A, and 193b4A) that have the different angles of inclination, respectively. Each of the projections 111bA, 173bB, and 193bB has a triangle shape that is asymmetrical across an axis of the first support shaft 74 and the second support shaft 94. The projection 111bA of a compatible joint applies a first force to the projection 173bB of a forward rotation output gear in a circumferential direction thereof when a forward rotation one-way clutch device (e.g., the forward rotation one-way clutch devices 70A, 70B, and 70C) transmits a driving force. The projection 111bA of the compatible joint applies a second force to the projection 193bB of a backward rotation output gear in a circumferential direction thereof when a backward rotation one-way clutch device (e.g., the backward rotation one-way clutch devices 90A, 90B, and 90C) transmits a driving force. The projections 111bA, 173bB, and 193bB cause the first force to be different from the second force.

Load torque applied when the forward rotation one-way clutch device transmits the driving force may be different from load torque applied when the backward rotation one-way clutch device transmits the driving force. In this case, when one of the forward rotation one-way clutch device and the backward rotation one-way clutch device, that is applied with greater load torque, transmits the driving force, a slope of the projection 111bA of the compatible joint, that has a smaller angle of inclination with respect to the axial direction of the first support shaft 74 and the second support shaft 94, meshes with the projection 173bB of the forward rotation output gear or the projection 193bB of the backward rotation output gear. Accordingly, the forward rotation one-way clutch device and the backward rotation one-way clutch device transmit the driving force properly.

FIG. 17B illustrates projections 111bB, 173bC, and 193bC that have a tip t4 as a plane parallel to the circumferential direction of the compatible joint, the forward rotation output gear, and the backward rotation output gear. Each of the projections 111bB, 173bC, and 193bC has a trapezoidal shape when seen in a radial direction of the compatible joint, the forward rotation output gear, and the backward rotation output gear. Since the tip t4 of each of the projections 111bB, 173bC, and 193bC is planar, the compatible joint, the forward rotation output gear, and the backward rotation output gear are advantageously manufactured with the molds having an increased strength. However, with the projections 111bB, 173bC, and 193bC having the planar tip t4, when a driving force is transmitted, the tips t4 of the projections 111bB of the compatible joints may contact the tip t4 of the projection 173bC of the forward rotation output gear and the tip t4 of the projection 193bC of the backward rotation output gear, respectively. Hence, the projection 111bB may not enter a gap between the adjacent projections 173bC of the forward rotation output gear and a gap between the adjacent projections 193bC of the backward rotation output gear. To address the circumstance, both ends of the planar tip t4 in the circumferential direction of the compatible joint, the forward rotation output gear, and the backward rotation output gear may be rounded. Alternatively, the planar tip t4 may be shortened.

Conversely, according to the embodiments described above, as illustrated in FIG. 11, the tips t1, t2, and t3 of the projections 111b, 173bA, and 193bA, respectively, define an acute angle. Hence, when a driving force is transmitted, the forward rotation pressing portion 71b of the forward rotation input gear 71 and the backward rotation pressing portion 91b of the backward rotation input gear 91 press the projection 111b of the second engaging portion 110b of the compatible joint 110 to enter a gap between the adjacent projections 173bA of the forward rotation output engaging portion 73bA of the forward rotation output gear 73A and a gap between the adjacent projections 193bA of the backward rotation output engaging portion 93bA of the backward rotation output gear 93A properly. Accordingly, when the driving force is transmitted, the second engaging portions 110b properly and advantageously mesh with the forward rotation output engaging portion 73bA and the backward rotation output engaging portion 93bA, respectively.

As the driving motor 61 rotates forward and backward, the forward rotation one-way clutch device (e.g., the forward rotation one-way clutch devices 70A, 70B, and 70C) and the backward rotation one-way clutch device (e.g., the backward rotation one-way clutch devices 90A, 90B, and 90C) transmit a driving force to the second rotator to rotate the second rotator forward. The second rotator is not limited to the fixing roller 44a. The second rotator is a rotator that rotates in a predetermined direction for printing. For example, the second rotator may be the photoconductor 1, the charging roller 4, a rotator of the developing device 8 such as the developing roller 8a, the first screw 8b, the second screw 8c, and the inclined screw 8d, the agitator 9b of the toner cartridge 9, the transfer roller 10, and a conveyance roller that conveys the recording sheet S such as the body feed roller 41, the bypass sheet feed roller 32, and the registration roller pair 43. The forward rotation one-way clutch device and the backward rotation one-way clutch device may drive and rotate a plurality of rotators.

The above describes the embodiments of the present disclosure. However, the technology of the present disclosure is not limited to the specific embodiments and allows various deformation and modification within the scope of the present disclosure unless the above descriptions limit deformation and modification.

The embodiments described above are examples and achieve advantages peculiar to aspects below, respectively.

A description is provided of a first aspect of the technology of the present disclosure.

As illustrated in FIG. 11, a one-way clutch device (e.g., the forward rotation one-way clutch devices 70A, 70B, and 70C and the backward rotation one-way clutch devices 90A, 90B, and 90C) includes an input member (e.g., the forward rotation input gears 71 and 71A and the backward rotation input gears 91 and 91A), an output member (e.g., the forward rotation output gear 73A, the backward rotation output gear 93A, and the compatible output gear 112), and a joint (e.g., the compatible joint 110, the forward rotation joint 72A, and the backward rotation joint 92A).

The input member includes an input engaging portion (e.g., the forward rotation input engaging portions 71c and 71cA and the backward rotation input engaging portions 91c and 91cA). The input member receives a driving force from a driving source (e.g., the driving motor 61). The output member is coaxial with the input member. The output member includes an output engaging portion (e.g., the forward rotation output engaging portion 73bA and the backward rotation output engaging portion 93bA). The output member outputs the driving force. The joint is movably disposed between the input member and the output member in an axial direction of the input member and the output member. The joint includes a first engaging portion (e.g., the first engaging portion 110a, the first forward rotation engaging portion 72aA, and the first backward rotation engaging portion 92aA) that engages the input engaging portion and a second engaging portion (e.g., the second engaging portion 110b, the second forward rotation engaging portion 72bA, and the second backward rotation engaging portion 92bA) that engages or meshes with the output engaging portion.

As the input member rotates in a driving force transmitting rotation direction to transmit the driving force to the output member that outputs the driving force, the input engaging portion engages the first engaging portion and the second engaging portion engages or meshes with the output engaging portion to transmit the driving force. As the input member rotates in a driving force interrupting rotation direction, that is opposite to the driving force transmitting rotation direction, to interrupt transmission of the driving force, the second engaging portion disengages the output engaging portion to interrupt transmission of the driving force.

The joint has an opposed face that is disposed opposite the output member and is perpendicular to an axial direction of the joint. The second engaging portion is disposed on the opposed face. The second engaging portion includes a plurality of projections (e.g., the projections 111b, 111bA, and 111bB) that projects in the axial direction of the joint. The projections are arranged in a circumferential direction of the joint. The output member has an opposed face that is disposed opposite the joint and is perpendicular to the axial direction of the output member. The output engaging portion is disposed on the opposed face. The output engaging portion includes a plurality of projections (e.g., the projections 173bA, 173bB, 173bC, 193bA, 193bB, and 193bC) that projects in the axial direction of the output member. The projections are arranged in a circumferential direction of the output member. Each of the projections of the second engaging portion and the output engaging portion includes a first slope (e.g., the first slopes 111b3, 111b3A, 173b3, 173b3A, 193b3, and 193b3A) and a second slope (e.g., the second slopes 111b4, 111b4A, 173b4, 173b4A, 193b4, and 193b4A). The first slope has a height that decreases gradually from a tip (e.g., the tips t1, t2, t3, and t4) of the projection in the driving force transmitting rotation direction. The second slope has a height that decreases gradually from the tip of the projection in the driving force interrupting rotation direction.

A description is provided of a construction of a comparative one-way clutch device.

The comparative one-way clutch device includes a driving force transmitting member serving as a joint that includes a second engaging portion having a construction below. For example, the second engaging portion has an opposed face that is disposed opposite an output gear serving as an output member that outputs a driving force received from the driving force transmitting member. The opposed face is perpendicular to an axial direction of the driving force transmitting member. A plurality of projections is disposed on the opposed face and projects in the axial direction of the driving force transmitting member. The projections are arranged in a circumferential direction of the driving force transmitting member. Each of the projections has a plane and a slope. The plane is perpendicular to the circumferential direction of the driving force transmitting member and is parallel to the axial direction of the driving force transmitting member. The slope has a height that decreases gradually from a tip of the projection toward an upstream in one direction as a rotation direction in which the driving force transmitting member rotates to transmit the driving force. The projection has a right-angled triangle shape when seen in a radial direction of the driving force transmitting member.

The output gear includes an output engaging portion that has an opposed face that is disposed opposite the driving force transmitting member and is perpendicular to an axial direction of the output gear. A plurality of projections is disposed on the opposed face and projects in the axial direction of the output gear. The projections are arranged in a circumferential direction of the output gear. Each of the projections includes a plane and a slope. The plane is perpendicular to the circumferential direction of the output gear and is parallel to the axial direction of the output gear. The slope has a height that decreases gradually from a tip of the projection toward a downstream in one direction as a rotation direction in which the output gear rotates to transmit the driving force. The projection has a right-angled triangle shape when seen in a radial direction of the output gear.

The comparative one-way clutch device further includes an input gear serving as an input member that transmits a driving force to the driving force transmitting member. The driving force transmitting member has an opposed face that is disposed opposite the input gear. A first engaging portion and an input side slope are disposed on the opposed face. The first engaging portion projects in the axial direction of the driving force transmitting member and engages an input engaging portion of the input gear. The input side slope extends from the first engaging portion toward the upstream in the one direction and has a height that decreases gradually.

As a driving motor rotates forward and the input gear rotates in a driving force transmitting rotation direction to transmit the driving force, the input engaging portion of the input gear comes into contact with the input side slope of the driving force transmitting member in an axial direction of the input gear and presses the driving force transmitting member against the output gear, moving the driving force transmitting member toward the output gear. As the input engaging portion of the input gear comes into contact with the first engaging portion of the driving force transmitting member in a circumferential direction of the input gear, the input engaging portion engages the first engaging portion. Accordingly, the input gear transmits the driving force to the driving force transmitting member. Thus, the driving force transmitting member rotates together with the input gear.

As the driving force transmitting member rotates, the plane of each of the projections of the second engaging portion of the driving force transmitting member comes into contact with the plane of each of the projections of the output engaging portion of the output gear. The second engaging portion engages the output engaging portion. Thus, the driving force transmitting member transmits the driving force to the output gear.

As the driving motor rotates backward and the input gear rotates in a driving force interrupting rotation direction, that is opposite to the driving force transmitting rotation direction, to interrupt transmission of the driving force, the input engaging portion separates from the input side slope. As the input gear rotates for a predetermined amount in the driving force interrupting rotation direction, the input engaging portion comes into contact with the first engaging portion of the driving force transmitting member in the driving force interrupting rotation direction. The input engaging portion engages the first engaging portion again. Accordingly, the input gear transmits the driving force to the driving force transmitting member. Thus, the driving force transmitting member rotates together with the input gear.

As the driving force transmitting member rotates in the driving force interrupting rotation direction together with the input gear, the slope of each of the projections of the output engaging portion presses the slope of the second engaging portion against the input gear. As described above, when the driving motor rotates backward, the input engaging portion separates from the input side slope. Hence, the slope of each of the projections of the output engaging portion presses and moves the driving force transmitting member against the input gear. Accordingly, the second engaging portion disengages the output engaging portion, interrupting transmission of the driving force.

However, two comparative one-way clutch devices incorporating the input members such as the input gears that rotate in different driving force transmitting rotation directions, respectively, may not employ a compatible member.

In the comparative one-way clutch device, each of the projections of the second engaging portion and the output engaging portion includes the plane and the slope. The plane is perpendicular to the circumferential direction of the driving force transmitting member and the output gear and is parallel to the axial direction of the output gear. When the input gear serving as the input member rotates in the driving force transmitting rotation direction, the plane of the second engaging portion engages the plane of the output engaging portion. Accordingly, when the input gear serving as the input member rotates in the driving force transmitting rotation direction, the output engaging portion applies a reaction force to the second engaging portion in the circumferential direction of the driving force transmitting member.

The comparative one-way clutch device is hereinafter referred to as a forward rotation one-way clutch device. A one-way clutch device incorporating an input member that rotates in a driving force transmitting rotation direction opposite to a driving force transmitting rotation direction of the input member of the comparative one-way clutch device is hereinafter referred to as a backward rotation one-way clutch device. The backward rotation one-way clutch device does not employ a shape of the projection of the forward rotation one-way clutch device, that is, the comparative one-way clutch device, as a shape of a projection of each of a second engaging portion and an output engaging portion of an output member. It is because the driving force transmitting rotation direction of the forward rotation one-way clutch device is equivalent to the driving force interrupting rotation direction of the backward rotation one-way clutch device. If the backward one-way clutch device employs the shape of the projection of the comparative one-way clutch device as the shape of the projection of the second engaging portion and the output engaging portion of the output member, when the joint rotates in the driving force interrupting rotation direction together with the input member, the output engaging portion applies a reaction force to the second engaging portion in the circumferential direction of the joint. Accordingly, the second engaging portion does not move toward the input member. The second engaging portion does not disengage the output engaging portion of the output member and therefore does not interrupt transmission of the driving force.

To address the circumstance, two one-way clutch devices that are different from each other in the driving force transmitting rotation direction incorporate the joints and the output members that include the second engaging portions and the output engaging portions that include the projections having different shapes, respectively.

Conversely, according to the first aspect of the technology of the present disclosure, each of the projections of the second engaging portion and the output engaging portion includes the first slope and the second slope. The first slope has the height that decreases gradually from the tip of the projection in the driving force transmitting rotation direction. The second slope has the height that decreases gradually from the tip of the projection in the driving force interrupting rotation direction. Accordingly, as the joint (e.g., the compatible joint 110) rotates in one direction, the first slope (e.g., the first slopes 173b3 and 193b3) of the output engaging portion (e.g., the forward rotation output engaging portion 73bA and the backward rotation output engaging portion 93bA) generates a reaction force that presses the second slope 111b4 of the second engaging portion 110b against the input member. As the joint (e.g., the compatible joint 110) rotates in a direction opposite to the one direction, the second slope (e.g., the second slopes 173b4 and 193b4) of the output engaging portion (e.g., the forward rotation output engaging portion 73bA and the backward rotation output engaging portion 93bA) generates a reaction force that presses the first slope 111b3 of the second engaging portion 110b against the input member. Thus, when the joint rotates in the one direction and when the joint rotates in the direction opposite to the one direction, the reaction force generated by the output engaging portion presses the joint against the input member. Accordingly, the second engaging portion disengages the output engaging portion, interrupting transmission of the driving force.

Hence, even if the two one-way clutch devices that are different from each other in the driving force transmitting rotation direction employ identical joints and identical output members, respectively, the two one-way clutch devices interrupt transmission of the driving force properly. When the driving force is transmitted, the input member presses the joint against the output member as described above. Hence, even if the reaction force generated by the output engaging portion presses the joint against the input member, the joint does not move toward the input member and does not interrupt transmission of the driving force.

Accordingly, the two one-way clutch devices that are different from each other in the driving force transmitting rotation direction of the input member employ compatible joints and compatible output members, respectively, reducing costs.

A description is provided of a second aspect of the technology of the present disclosure.

According to the first aspect, the input member (e.g., the forward rotation input gear 71 and the backward rotation input gear 91) includes a pressing portion (e.g., the forward rotation pressing portion 71b and the backward rotation pressing portion 91b) that presses the joint against the output member (e.g., the forward rotation output gear 73A and the backward rotation output gear 93A) when the input member rotates in the driving force transmitting rotation direction.

Accordingly, as described above in the embodiments with reference to FIGS. 14A and 14B, the pressing portion (e.g., the forward rotation pressing portion 71b and the backward rotation pressing portion 91b) presses the joint (e.g., the compatible joint 110) against the output member when the driving force is transmitted. Even if the reaction force generated by the output engaging portion presses the joint against the input member, the joint does not move toward the input member and does not interrupt transmission of the driving force. Accordingly, the output member outputs the driving force transmitted from the driving source (e.g., the driving motor 61) properly.

A description is provided of a third aspect of the technology of the present disclosure.

According to the first aspect or the second aspect, each of the projections (e.g., the projections 111b) of the second engaging portion (e.g., the second engaging portion 110b) and the projections (e.g., the projections 173bA and 193bA) of the output engaging portion (e.g., the forward rotation output engaging portion 73bA and the backward rotation output engaging portion 93bA) includes the tip (e.g., the tips t1, t2, and t3) that has an acute angle.

Accordingly, as described above in the embodiments, compared to a configuration in which the tip of each of the projections includes a plane that is perpendicular to the axial direction of the output member, when a driving force is transmitted, the projection (e.g., the projection 111b) of the second engaging portion of the joint (e.g., the compatible joint 110) enters a gap between the adjacent projections (e.g., the projections 173bA and 193bA) of the output engaging portion of the output member (e.g., the forward rotation output gear 73A and the backward rotation output gear 93A) properly. When the driving force is transmitted, the second engaging portion (e.g., the second engaging portion 110b) meshes with the output engaging portion (e.g., the forward rotation output engaging portion 73bA and the backward rotation output engaging portion 93bA) properly.

A description is provided of a fourth aspect of the technology of the present disclosure.

According to the first aspect or the second aspect, each of the projections (e.g., the projections 111bB) of the second engaging portion (e.g., the second engaging portion 110b) and the projections (e.g., the projections 173bC and 193bC) of the output engaging portion (e.g., the forward rotation output engaging portion 73bA and the backward rotation output engaging portion 93bA) includes the tip (e.g., the tip t4) that defines a plane being perpendicular to the axial direction of the output member.

Accordingly, as described above with reference to FIG. 17B, compared to a configuration in which the tip of each of the projections has an acute angle, the joint and the output member are manufactured with the molds having an increased strength.

A description is provided of a fifth aspect of the technology of the present disclosure.

A driver (e.g., the drivers 60A, 60B, and 60C) includes a driving source (e.g., the driving motor 61) that rotates forward and backward and a driving force transmitter (e.g., the driving force transmitter 82A) that transmits a driving force generated by the driving source. The driving force transmitter includes one-way clutch devices (e.g., the forward rotation one-way clutch devices 70A, 70B, and 70C and the backward rotation one-way clutch devices 90A, 90B, and 90C). The driver employs the one-way clutch devices according to any one of the first to fourth aspects.

Accordingly, the driver reduces costs.

A description is provided of a sixth aspect of the technology of the present disclosure.

According to the fifth aspect, the driving force transmitter includes a first driving force transmission path (e.g., the first forward rotation driving force transmission path T11) and a second driving force transmission path (e.g., the second forward rotation driving force transmission path T12). As the driving source (e.g., the driving motor 61) rotates forward, the first driving force transmission path outputs the driving force generated by the driving source. According to the embodiments, the first driving force transmission path is constructed of the motor input gear 62, the forward rotation one-way clutch device (e.g., the forward rotation one-way clutch devices 70A, 70B, and 70C), and the fixing output gear 64. As the driving source rotates backward, the second driving force transmission path outputs the driving force generated by the driving source. According to the embodiments, the second driving force transmission path is constructed of the motor input gear 62, the backward rotation one-way clutch device (e.g., the backward rotation one-way clutch devices 90A, 90B, and 90C), the forward rotation output gear 73A or the compatible output gear 112 of the forward rotation one-way clutch device, and the fixing output gear 64. The one-way clutch devices are disposed in the first driving force transmission path and the second driving force transmission path, respectively. The joint of the one-way clutch device (e.g., the forward rotation one-way clutch devices 70A, 70B, and 70C) disposed in the first driving force transmission path is compatible with the joint of the one-way clutch device (e.g., the backward rotation one-way clutch devices 90A, 90B, and 90C) disposed in the second driving force transmission path.

Accordingly, as described above in the embodiments, the driver reduces manufacturing costs of the molds and the driver.

A description is provided of a seventh aspect of the technology of the present disclosure.

According to the sixth aspect, the output member (e.g., the forward rotation output gear 73A and the compatible output gear 112) of the one-way clutch device (e.g., the forward rotation one-way clutch devices 70A, 70B, and 70C) disposed in the first driving force transmission path is compatible with the output member (e.g., the backward rotation output gear 93A and the compatible output gear 112) of the one-way clutch device (e.g., the backward rotation one-way clutch devices 90A, 90B, and 90C) disposed in the second driving force transmission path.

Accordingly, as described above in the embodiments, the driver further reduces manufacturing costs of the molds and the driver.

A description is provided of an eighth aspect of the technology of the present disclosure.

According to the sixth aspect or the seventh aspect, an angle of inclination of the first slope (e.g., the first slopes 111b3A, 173b3A, and 193b3A) of each of the projection (e.g., the projection 111bA) of the second engaging portion (e.g., the second engaging portion 110b) and the projection (e.g., the projections 173bB and 193bB) of the output engaging portion (e.g., the forward rotation output engaging portion 73bA and the backward rotation output engaging portion 93bA) is different from an angle of inclination of the second slope (e.g., the second slopes 111b4A, 173b4A, and the 193b4A).

Accordingly, as described above with reference to FIG. 17A, when the one-way clutch device (e.g., the forward rotation one-way clutch devices 70A, 70B, and 70C) disposed in the first driving force transmission path outputs a driving force, the driving force applied to the projection of the output engaging portion of the output member (e.g., the forward rotation output gear 73A and the compatible output gear 112) in the circumferential direction of the output member is different from the driving force applied to the projection of the output engaging portion of the output member (e.g., the backward rotation output gear 93A and the compatible output gear 112) in the circumferential direction of the output member when the one-way clutch device (e.g., the backward rotation one-way clutch devices 90A, 90B, and 90C) disposed in the second driving force transmission path outputs the driving force. Accordingly, in a case that load torque that generates when the one-way clutch device disposed in the first driving force transmission path outputs the driving force is different from load torque that generates when the one-way clutch device disposed in the second driving force transmission path outputs the driving force, the driver employs a construction according to the eighth aspect. Thus, the one-way clutch device disposed in the first driving force transmission path and the one-way clutch device disposed in the second driving force transmission path transmit the driving force properly.

A description is provided of a ninth aspect of the technology of the present disclosure.

According to any one of the sixth to eighth aspects, the driving force transmitter includes a forward and backward rotation driving force transmission path (e.g., the forward and backward rotation driving force transmission path T10), a first forward rotation driving force transmission path (e.g., the first forward rotation driving force transmission path T11), and a second forward rotation driving force transmission path (e.g., the second forward rotation driving force transmission path T12). The forward and backward rotation driving force transmission path transmits the driving force to a first rotator (e.g., the sheet ejection-reverse roller pair 46), drives and rotates the first rotator forward when the driving source (e.g., the driving motor 61) rotates forward, and drives and rotates the first rotator backward when the driving source rotates backward. According to the embodiments, the forward and backward rotation driving force transmission path is constructed of the motor input gear 62, the forward rotation input gear 71 or 71A, and the sheet ejection-reverse output gear 63. When the driving source rotates forward, the first forward rotation driving force transmission path transmits a driving force to a second rotator (e.g., the fixing roller 44a) to drive and rotate the second rotator forward. When the driving source rotates backward, the second forward rotation driving force transmission path transmits a driving force to the second rotator to drive and rotate the second rotator forward. The first forward rotation driving force transmission path serves as the first driving force transmission path. The second forward rotation driving force transmission path serves as the second driving force transmission path.

Accordingly, the driving force transmitter is manufactured at reduced costs. Additionally, the single driving source drives and rotates the first rotator (e.g., the sheet ejection-reverse roller pair 46) forward and backward and the second rotator (e.g., the fixing roller 44a) forward constantly. Hence, compared to a configuration in which separate driving sources drive and rotate the first rotator forward and backward and the second rotator forward, respectively, the driver reduces the number of parts and manufacturing costs further.

A description is provided of a tenth aspect of the technology of the present disclosure.

According to the ninth aspect, the first rotator is a sheet ejection-reverse roller (e.g., the sheet ejection-reverse roller pair 46) that ejects a sheet (e.g., the recording sheet S) onto an output tray (e.g., the output tray 81) or conveys the sheet to a reverse path (e.g., the reverse reconveyance path R5) that reverses the sheet. The second rotator is a fixing roller (e.g., the fixing roller 44a) of a fixing device (e.g., the fixing device 44) that fixes a toner image on the sheet.

Accordingly, as described above in the embodiments, even when the driver drives and rotates the sheet ejection-reverse roller backward and conveys the sheet to the reverse path, the driver drives and rotates the fixing roller forward. Consequently, while the sheet ejection-reverse roller conveys the sheet to the reverse path also, the fixing roller conveys the sheet in the fixing device to fix the toner image on the sheet, preventing degradation of productivity.

A description is provided of an eleventh aspect of the technology of the present disclosure.

As illustrated in FIG. 1, an image forming apparatus (e.g., the printer 1000) includes the driver according to any one of the sixth to tenth aspects.

Accordingly, the image forming apparatus reduces costs.

According to the embodiments described above, the printer 1000 serves as the image forming apparatus. Alternatively, the image forming apparatus may be a copier, a facsimile machine, a multifunction peripheral (MFP) having at least two of copying, printing, scanning, facsimile, and plotter functions, an inkjet recording apparatus, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A one-way clutch device for transmitting a driving force generated by a driving source, the one-way clutch device comprising:
an input member to receive the driving force from the driving source, the input member to rotate in a driving force transmitting rotation direction to transmit the driving force and a driving force interrupting rotation direction opposite to the driving force transmitting rotation direction to interrupt transmission of the driving force;
an output member to output the driving force; and
a joint to engage the output member, the joint including a plurality of first projections disposed opposite the output member, the first projections projecting in an axial direction of the joint and being arranged in a circumferential direction of the joint,
the output member including a plurality of second projections disposed opposite the joint, the second projections projecting in an axial direction of the output member and being arranged in a circumferential direction of the output member,
each of the first projections and the second projections including:
a first slope having a height that decreases gradually from a tip of each of the first projections and the second projections in the driving force transmitting rotation direction; and
a second slope having a height that decreases gradually from the tip of each of the first projections and the second projections in the driving force interrupting rotation direction.

2. The one-way clutch device according to claim 1,
wherein the joint moves between the input member and the output member in the axial direction of the joint, and
wherein the joint further includes:
a first engaging portion to engage the input member; and
a second engaging portion to engage the output member, the second engaging portion disposed on an opposed face of the joint, the opposed face that is disposed opposite the output member and is perpendicular to the axial direction of the joint.

3. The one-way clutch device according to claim 2,
wherein the input member includes an input engaging portion to engage the first engaging portion of the joint, and
wherein the output member further includes an output engaging portion to engage the second engaging portion of the joint.

4. The one-way clutch device according to claim 3,
wherein the output member is coaxial with the input member, and
wherein the output engaging portion is disposed on an opposed face of the output member, the opposed face that is disposed opposite the joint and is perpendicular to the axial direction of the output member.

5. The one-way clutch device according to claim 4,
wherein, as the input member rotates in the driving force transmitting rotation direction to transmit the driving force to the output member that outputs the driving force, the input engaging portion engages the first engaging portion and the second engaging portion engages the output engaging portion to transmit the driving force, and
wherein, as the input member rotates in the driving force interrupting rotation direction, the second engaging portion disengages the output engaging portion to interrupt transmission of the driving force.

6. The one-way clutch device according to claim 5,
wherein the input member further includes a pressing portion to press the joint against the output member as the input member rotates in the driving force transmitting rotation direction.

7. The one-way clutch device according to claim 1,
wherein the tip of each of the first projections and the second projections has an acute angle.

8. The one-way clutch device according to claim 1,
wherein the tip of each of the first projections and the second projections defines a plane being perpendicular to the axial direction of the output member.

9. The one-way clutch device according to claim 1,
wherein each of the first projections and the second projections has an isosceles triangle shape when seen in a radial direction of the joint and the output member.

10. The one-way clutch device according to claim 1,
wherein the input member includes an input gear and the output member includes an output gear.

11. A driver comprising:
a driving source to rotate forward and backward and generate a driving force; and
a driving force transmitter to transmit the driving force,
the driving force transmitter including:
a first one-way clutch device; and
a second one-way clutch device disposed opposite the first one-way clutch device,
each of the first one-way clutch device and the second one-way clutch device including:
an input member to receive the driving force from the driving source, the input member to rotate in a driving force transmitting rotation direction to transmit the driving force and a driving force interrupting rotation direction opposite to the driving force transmitting rotation direction to interrupt transmission of the driving force;
an output member to output the driving force; and
a joint to engage the output member, the joint including a plurality of first projections disposed opposite the output member, the first projections projecting in an axial direction of the joint and being arranged in a circumferential direction of the joint,
the output member including a plurality of second projections disposed opposite the joint, the second projections projecting in an axial direction of the output member and being arranged in a circumferential direction of the output member,
each of the first projections and the second projections including: a first slope having a height that decreases gradually from a tip of each of the first projections and the second projections in the driving force transmitting rotation direction; and a second slope having a height that decreases gradually from the tip of each of the first projections and the second projections in the driving force interrupting rotation direction.

12. The driver according to claim 11,
wherein the driving force transmitter further includes:
a first driving force transmission path to output the driving force generated by the driving source as the driving source rotates forward; and
a second driving force transmission path to output the driving force generated by the driving source as the driving source rotates backward, and
wherein the first one-way clutch device is disposed in the first driving force transmission path and the second one-way clutch device is disposed in the second driving force transmission path.

13. The driver according to claim 12,
wherein the joint of the first one-way clutch device is compatible with the joint of the second one-way clutch device.

14. The driver according to claim 13,
wherein the output member of the first one-way clutch device is compatible with the output member of the second one-way clutch device.

15. The driver according to claim 13,
wherein an angle of inclination of the first slope is different from an angle of inclination of the second slope.

16. An image forming apparatus comprising:
a driver;
a first rotator coupled with the driver; and
a second rotator coupled with the driver,
the driver including:
a driving source to rotate forward and backward and generate a driving force; and
a driving force transmitter to transmit the driving force,
the driving force transmitter including:
a first one-way clutch device; and
a second one-way clutch device disposed opposite the first one-way clutch device,
each of the first one-way clutch device and the second one-way clutch device including:
an input member to receive the driving force from the driving source, the input member to rotate in a driving force transmitting rotation direction to transmit the driving force and a driving force interrupting rotation direction opposite to the driving force transmitting rotation direction to interrupt transmission of the driving force;
an output member to output the driving force; and
a joint to engage the output member, the joint including a plurality of first projections disposed opposite the output member, the first projections projecting in an axial direction of the joint and being arranged in a circumferential direction of the joint,
the output member including a plurality of second projections disposed opposite the joint, the second projections projecting in an axial direction of the output member and being arranged in a circumferential direction of the output member, each of the first projections and the second projections including: a first slope having a height that decreases gradually from a tip of each of the first projections and the second projections in the driving force transmitting rotation direction; and a second slope having a height that decreases gradually from the tip of each of the first projections and the second projections in the driving force interrupting rotation direction.

17. The image forming apparatus according to claim 16,
wherein the driving force transmitter further includes:
a forward and backward rotation driving force transmission path to transmit the driving force to the first rotator to rotate the first rotator forward as the driving source rotates forward and rotate the first rotator backward as the driving source rotates backward;
a first driving force transmission path to transmit the driving force to the second rotator to rotate the second rotator forward as the driving source rotates forward; and
a second driving force transmission path to transmit the driving force to the second rotator to rotate the second rotator forward as the driving source rotates backward.

18. The image forming apparatus according to claim 17, further comprising:
an output tray to receive a sheet; and
a reverse path to reverse the sheet,
wherein the first rotator includes a sheet ejection-reverse roller to eject the sheet onto the output tray and convey the sheet to the reverse path, and
wherein the second rotator includes a fixing roller to fix a toner image on the sheet.

19. The image forming apparatus according to claim 17,
wherein the driver further includes:
a motor input gear coupled with the driving source;
a sheet ejection-reverse output gear to mesh with the input member; and
a fixing output gear combined with the output member,
wherein the forward and backward rotation driving force transmission path is defined by the motor input gear, the input member of the first one-way clutch device, and the sheet ejection-reverse output gear,
wherein the first driving force transmission path is defined by the motor input gear, the first one-way clutch device, and the fixing output gear, and
wherein the second driving force transmission path is defined by the motor input gear, the second one-way clutch device, the output member of the first one-way clutch device, and the fixing output gear.
